(19) United States
(12) Patent Application Publication
(10) Pub. No.: US 2003/0165666 A1
(43) Pub. Date: Sep. 4, 2003

(54) Filler lens and production method therefor

(75) Inventors: Akira Fujiwara, Shizuoka (JP); Chikara Murata, Shizuoka (JP); Shuji Mitani, Shizuoka (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Tomoegawa Paper Co., Ltd.

(21) Appl. No.: 10/351,302

(22) Filed: Jan. 27, 2003

Related U.S. Application Data
(62) Division of application No. 09/601,329, filed on Sep. 25, 2000.
Application No. 09/601,329 is a 371 of international application No. PCT/JP99/06703, filed on Nov. 30, 1999.

(30) Foreign Application Priority Data
Dec. 9, 1998 (JP) 10-350446
Sep. 29, 1999 (JP) 11-276554
Oct. 1, 1999 (JP) 11-281452
Aug. 31, 1999 (JP) 11-246136
Sep. 30, 1999 (JP) 11-280798
Oct. 5, 1999 (JP) 11-284768

(51) Int. Cl. B32B 1/00

(52) U.S. Cl. 428/143

(57) ABSTRACT

A filler lens which yields sufficient light diffusivity in both the cases in which light is transmitted from the film side and in which it is transmitted from the filler side and which has a light transmittance superior to that of conventional light diffusing members in which a filler layer is formed as a multilayer, and a production method therefor are disclosed. The filler lens comprises a sheet-shaped base material (1), a binding layer (2) provided on this base material (1) directly or via another layer, and a filler layer (3A) embedded in the surface of the binding layer (2). In the filler layer (3A), the fillers (3) form a monolayer at a high density and part of the filler (3) protrudes from the surface of the binding layer (2).

### BACKGROUND OF THE INVENTION

The present invention relates to a filler lens which is suitable for use in displays such as LCDs, ELs, FEDs, etc., and which in particular, yields superior effects in which nonuniformity of luminance in these displays is avoided, contrast therein is improved, and viewing angle is broadened, and to a production method therefor.

There has recently been remarkable progress in displays such as LCDs, ELs, FEDs, etc. In particular, the LCD has spread through numerous applications such as notebook-size personal computers, portable type terminals, etc., and this is anticipated to continue in the future. LCDs may be divided into reflecting types and transmitting types, depending on the manner in which illuminating light is taken into the liquid crystal panel. The reflecting type uses a method in which a reflecting plate on which an aluminum film, etc., is adhered or deposited having a high reflectivity is arranged in the back of a liquid crystal panel; external light transmitted from a surface side of the display is reflected by the reflecting plate; the liquid crystal panel is illuminated; and a liquid crystal image is obtained. In contrast, the transmitting type uses a method in which a liquid crystal panel is illuminated by a back light unit arranged in the back of the liquid crystal panel. In the reflecting type, in order to prevent loss of contrast in which the native color of the aluminum appears, the background color is made to closely resemble the color of white paper by inserting a medium which moderately diffuses the light between the liquid crystal panel and the reflecting plate, or by diffusing the light using a film in which aluminum is deposited on a matte plane of a film subjected to a matte processing (a treatment for roughening on the surface), etc. In addition, the back light unit in the transmitting type is generally provided with a light source such as an acrylic light conducting board having a cold cathode tube and a light diffusing board diffusing light from the light source, and is a composition in which uniform planar light illuminates the liquid crystal panel.

Thus, in either of the methods used in the reflecting type and transmitting type, a medium having a light diffusivity (hereinafter referred to as “light diffusion material”) is approximately used. As this light diffusion material, for example, a material in which adhesive resin dispersed fillers having light diffusivity is laminated on one surface of a transparent resin film, can be employed. Such conventional light diffusion materials have been produced by a method in which a coating material is prepared by dispersing fillers in a solution dissolved solvent in adhesive resin, and this coating material is coated on a film by a spray or a coater. In FIG. 2, a light diffusion material obtained by such a production method is schematically shown, and a binding layer 12 is formed on a film 11 by curing adhesive resin solution, and fillers 13 are dispersed in this binding layer 12.

With respect to total light diffusion transmittance and total light diffusion reflectance in the above conventional light diffusion material, the values in a direction of transmitted light in which light is transmitted from a filler side are almost similar to the values in a direction from a film side, and these show equal values. It is found that light diffusivity is the same regardless of the incidence direction of the light, that is, there is no directivity. This is the reason that fillers are perfectly embedded in a binding layer, fillers overlap in a thickness direction, and a multilayer is thereby formed. Furthermore, in such a composition, diffused lights cancel each other out, and the transmittance is thereby degraded (light energy is lost).

In addition, as a medium exhibiting similar light diffusivity, a lens film in which microlenses are formed on one surface of a transparent film by a method such as photolithography, etc., has been proposed. In this lens film, there is large difference between the case in which light is transmitted from a lens side and the case in which light is transmitted from a film side. Therefore, it has been apparent that the light diffusivity has a directionality. By applying this directionality, for example, in the case in which the filler lens is mounted on the above reflecting-type LCD, light from outside is efficiently reflected, and bright images having a high contrast can be thereby obtained.

Thus, it is understood that a lens-shaped light diffusion material is highly preferred as a light diffusion material. However, the photolithography is suitable for producing a microlens of 1 μm or less and it is unsuitable for large lens processing over 1 μm. In the case in which the lens is too small, it is difficult to produce since Newton's rings are generated.

Therefore, the inventors have thought that the light diffusivity having a directionality as shown in the above filler lens film (hereinafter referred to as the “lens effect”) is exhibited if fillers are embedded in a binding layer so that part of the filler protrudes from the surface thereof and the protruding fillers are formed into fine lenses, and the following production methods have been attempted. Firstly, a binding layer is formed on a film, fillers are adhered to the binding layer, and then the fillers are embedded in the binding layer using a pressure roller.

In this method, the pressing balance of the pressure roller is importance. In the case in which a pressure difference occurs between both edge portions and a central portion by the dispersion of film thickness, bending of the pressure roller, etc., at a place at which a large pressure is applied, a filler layer is easily formed as a multilayer since fillers are embedded over a desired depth. In contrast, at a place at which a slight pressure is applied, defects such as falling out of filler, etc., easily occur in the process for washing surplus filler, etc., since fillers are not sufficiently embedded in the binding layer. In particular, this phenomenon was remarkable in the case in which a large area is coated.

Furthermore, in the case in which fillers having a particle diameter of 15 μm or less are embedded, the specific surface area of the fillers is increased and the fluidity of the fillers is substantially deteriorated by effects of interparticle forces such as van der Waals forces, electrostatic attraction such as frictional electrostatic charging, etc. In addition, since the pressure from pressure rollers disperses and the pressure applied to each filler is lowered, other fillers cannot be embedded to uniform depth in spaces between the filler particles already adhered on the binding layer.

Due to the above problems, variation in the embedding depths of the fillers in the binding layer is increased, filling density of the fillers in the planar direction is often not uniform, and dense portions and sparse portions of the fillers in filling density are easily formed. Therefore, in this filler lens, the light diffusivity and the light transparency are not uniform depending on the portions, and the filler lens could not be used in practice.

FIG. 3A shows an optical photomicrograph at a magnification of 10× of a plane view of a filler lens produced using methylsilicone filler having a volume average particle diameter of 4.5 μm by the above production method using a pressure roller, and FIG. 3B shows an electron photomicrograph of a sectional view of the same filler lens at a magnification of 2,000×. As is apparent from FIG. 3A, the filling density of fillers is not uniform, and multilayers are partially formed. In addition, as is apparent from FIG. 3B, the embedding depths of fillers in the binding layer is not uniform.

### SUMMARY OF THE INVENTION

It is an object of the present invention to provide a filler lens in which light diffusivity and light transparency are high and uniform and in which light transparency is more superior than in conventional light diffusing members in which a filler layer is formed as a multilayer, and to provide a production method thereof.

1. First Embodiment

A filler lens according to the first embodiment of the present invention has been made in view of the above circumstances in the conventional art, and it is characterized by comprising a base material, a binding layer provided on the base material directly or via another layer, and a filler layer consisting of many fillers embedded in the surface of the binding layer so that part of the filler protrudes from the surface thereof. According to the present embodiment, a protruding portion of the filler in the filler layer exhibits a fine lens shape, and the above lens effect can be thereby obtained.

The filler layer in the filler lens of the present invention can yield a remarkable lens effect due to the filler. With respect to the lens effect, it is preferable that fillers be embedded as a monolayer in the surface of the binding layer so that part of the filler protrudes from the surface thereof, and it is more preferable each filler be placed in the planar direction at a high density. Hereinafter, a monolayer in the present invention refers to a layer formed so that fillers protruding from the surface of the binding layer have no overlap portion thereof.

FIG. 1 is a sectional view schematically showing an example of a filler lens according to the present invention. In this filler lens L, a binding layer 2 is coated directly on a base material 1, many fillers 3 are embedded as a monolayer in a surface of this binding layer 2 so that parts thereof protrude from a surface of the binding layer 2 and the fillers are placed in the planar direction at high density, and a filler layer 3A is thereby formed. In addition, in a filler lens of the present invention, a coating for improving light diffusivity may be applied on the surface of the filler layer, and other layers may be provided thereon.

Next, a production method for a filler lens according to the present invention is a suitable method for producing the above filler lens, and is characterized by comprising:

\mathring{1} a process for forming a binding layer on a base material directly or via another layer,

\mathring{2} a process for embedding fillers in a surface of the binding layer by pressure media, and

\mathring{3} a process for removing surplus fillers adhered to a laminated film formed above. Furthermore, a process for adhering fillers on the binding layer may be carried out before the process \mathring{2}, since defects on the outside such as falling out of fillers, etc., can be decreased, embedding of fillers can be surely carried out. As a specific method for embedding fillers in the binding layer in the process \mathring{2}, a method in which the fillers are struck by granular pressure media by vibrating and the fillers are thereby embedded in the binding layer, can be employed. According to the production method of the present invention, a filler lens can be produced, in which embedding depths of the fillers is made uniform, the fillers are placed in the planar direction at a high density, and the fillers are embedded as a monolayer in the surface of the binding layer so that part of the filler protrudes from the surface thereof.

In the following, constituent materials and production methods which are suitable for filler lenses obtained by the present invention will be explained.

A. Constituent Materials

(1) Base Material.

As a base material, well-known transparent films can be employed in the present invention. Specifically, various resin films consisting of polyethylene terephthalate (PET), polyethylene naphthalate (PEN), triacetyl cellulose (TAC), polyalate, polyimide, polyether, polycarbonate, polysulfone, polyethersulfone, cellophane, aromatic polyamide, polyethylene, polypropylene, polyvinyl alcohol, etc., can be suitably employed. In addition, base materials used in the present invention are not limited in such resin films, and hard plates consisting of the above resin, sheet shaped members consisting of glass material such as silica glass, soda glass, etc., other than the above resin plates, can also be employed.

Non-transparent base materials can also be employed even if light can penetrate therein, and in particular, in the case in which it is used in a liquid crystal display, etc., it is preferable that transparent base materials have a refractive index (Japanese Industrial Standard K-7142) of 1.45 to 1.55. Specifically, acrylic resin film such as triacetylcellulose (TAC), polymethyl methacrylate, etc., can be employed. The higher the transparency thereof, the more desirable the transparent substrate. The total light transmittance (Japanese Industrial Standard C-6714) is preferably 80% or more, is more preferably 85% or more, and is most preferably 90% or more. The Haze value (Japanese Industrial Standard K-7105) is preferably 3.0 or less, is more preferably 1.0 or less, and is most preferably 0.5 or less. In the case in which the transparent base material is used for a small and lightweight liquid crystal display, it is more preferable that the transparent base material be of a film shape. The thickness of the base material is desirably thin from the viewpoint of weight reduction, and it is preferably 1 μm to 5 mm in consideration of productivity. In addition, a lens having a convergence or diffusivity is formed on one surface of the base material, and a filler lens can be formed on the other surface of this base material directly or via another layer.

(2) Binding layer

The binding layer in the present invention is preferably specifically an adhesive layer in which adhesive is coated on the above base material. As an adhesive, resinoid adhesives such as acrylic type resin, polyester resin, epoxy resin, polyurethane type resin, silicone resin, phenol resin, melamine resin, urea resin, diallyl phthalate resin, guanamine resin, amino alkyd resin, melamine-urea cocondensated resin, etc., can be employed. These can be used alone or in combination, and polymerization promoters, solvents, viscosity modifiers, etc., can also be added as necessary. Of these resins, acrylic type resin is particularly preferred since transparency and adhesive strength are good, water resistance, heat resistance, light resistance, etc., are superior, and in addition, the refractive index is easily adjusted when the adhesive is used for liquid crystal displays, and the like.

As an acrylic type adhesive, a homopolymer or copolymer of acrylic monomer such as acrylic acid and an ester thereof, methacrylic acid and an ester thereof, acrylamide, acrylonitrile, etc., and a copolymer of at least one kind of the above acrylic monomers and aromatic vinyl monomer such as vinyl acetate, maleic anhydride, styrene, etc., can be employed. In particular, a copolymer consisting of a primary monomer for yielding adhesiveness such as ethylene acrylate, butylacrylate, 2-ethylhexyl acrylate, etc., a monomer as a cohesion component such as vinyl acetate, acrylonitrile, acrylamide, styrene, methacrylate, methylacrylate, etc., and a monomer having functional groups for improving adhesive strength and for initiating cross-linking, methacrylic acid, acrylic acid, itaconic acid, hydroxyethyl methacrylate, hydroxypropyl methacrylate, dimethylaminoethyl methacrylate, dimethylaminomethyl methacrylate, acrylamide, methylolacrylamide, glycidyl methacrylate, maleic anhydride, etc., can be preferably employed. The Tg (the glass transition point) of the copolymer is preferably −60 to −15° C., and the weight average molecular weight thereof is preferably 200,000 to 1,300,000.

In the case in which a binding layer consists of an adhesive in which the Tg is lower than −60° C. and an adhesive in which the weight average molecular weight is below 200,000, the fillers once adhered are torn away by the impulsive force of the pressure media since the layer is too soft, and defects such as falling out of filler, etc., occur easily. In addition, the adhesive adheres to the fillers after they are torn away, and the fillers are adhered on the filler layer again. Furthermore, in the case in which the binding layer is too soft, the fillers are rotated in a longitudinal direction on the surface of the binding layer by impact of the pressure media. Whereby, the filler position, at which the adhesive is adhered, appears on the surface of the filler layer and other fillers are adhered thereto, or the adhesive oozes from gaps of the fillers by the impulsive force of the pressure media or by capillarity, and other fillers are adhered thereto. Since by such phenomena the filler layer is easily formed as a multilayer constitution and the transparency is decreased, a soft binding layer is not desirable. Furthermore, in a further soft binding layer, mechanical strength, such as scratch resistance of a filler layer, is also decreased. In contrast, in the case of a binding layer in which the Tg is higher than −15° C. and an adhesive in which the weight average molecular weight is above 1,300,000, this is not desirable since the adhesion of filler to the binding layer is decreased and the fillers easily fall off in the process of washing off surplus fillers, etc.

In addition, with respect to the viscosity of adhesive for the present invention, a value in which the adhesive is dissolved so that total solid concentration in ethyl acetate is 25% and the viscosity is measured in a solution at 23° C. by a B-type viscometer, is preferably 500 to 20000 cps, and is more preferably 1500 to 5000 cps. When the viscosity is too low, fillers are easily embedded excessively, and when the viscosity is too high, it is difficult to embed the fillers. Furthermore, the holding power (Japanese Industrial Standard Z-023711) of this adhesive is preferably 0.5 mm or less. When this folding power is above 0.5 mm, a filler layer is easily formed as a multilayer, as described above, since the adhesive is soft. It is desirable in practice that the hardener be mixed so that adhesive strength (Japanese Industrial Standard Z-02378) of the binding layer is 100 g/25 mm or more. In the case in which the adhesive strength is below 100 g/25 mm, falling off of the filler occurs and environmental resistance is deteriorated. In particular, there is a risk that the binding layer will come off the transparent base material under high temperatures and high humidity.

Furthermore, in the adhesive of the present invention, as a hardener, for example, cross-linking agents of the metal chelate type, isocyanate type, or epoxy type, can be employed alone or in combination, as necessary. In this adhesive, a UV-curable adhesive added to a photopolymerizing monomer, oligomer, polymer, and photopolymerization initiator, may also be employed. Properties of the adhesive can be thereby appropriately adjusted. In the case in which this binding layer is suitably cured before a process for embedding fillers, the gel fraction after curing is preferably 40% or more, and is more preferably 60% or more. In the case in which the gel fraction is below 40%, there is a risk that the binding layer will soften under high temperatures and high humidity, the fillers will sink in the binding layer, and optical properties of the filler lens will change.

(3) Filler

As a filler of the present invention, an inorganic filler such as silica, glass, alumina, etc., an organic filler such as acrylic resin, polystyrene resin, polyethylene resin, epoxy resin, silicone resin, polyvinylidene fluoride, Teflon, divinylbenzene, phenol resin, urethane resin, cellulose acetate, nylon, cellulose, benzoguanamine, melamine resin, etc., or the like, can be employed. In particular, an organic filler is preferred from the viewpoint of light transparency and adhesion to a binding layer, and furthermore, acrylic beads, and silicone beads are preferred from the viewpoint of light resistance. In addition, in order to uniformly form the filler layer at high density, it is most preferable that silicone beads such as methylsilicone, etc., having a high fluidity, be employed. The inorganic filler such as silica, glass, etc, is not preferred, since the adhesion to the binding layer is inferior, and fillers easily fall out in the process for embedding fillers or the process for washing.

The filler is preferably globular as described above and a globular filler has a merit in that variation in the embedding depth is difficult to cause. The roundness is preferably 80% or more, is more preferably 85% or more, and is most preferably 90% or more. In addition, “roundness” is defined by the following general equation.

Roundness (%)=(4A/B2)×100

A: Projected area of filler particle

B: Circumference of filler particle

For example, projection images of fillers are obtained by photographing using a transmission electron microscope, and are subjected to an image analysis using an image analysis apparatus (for example, trade name: EXECL II; produced by Nippon Avionics Co., Ltd.), and the above A and B are thereby obtained. Subsequently, roundness can be calculated from the A and B. As is apparent from the above equation, the closer the particle approximates a true sphere, the closer the roundness approximates 100%, and in the case of an undefined shape, the roundness is less than that value. In the present specification, the average value measured with respect to 10 fillers is defined as roundness.

In addition, a filler having a volume average particle diameter of 1 to 50 μm, preferably 2 to 15 μm, can be used in the present invention, and in particular, when the filler is used for liquid crystal displays, etc., it is preferably 2 to 10 μm. Here, in the case in which the particle diameter of filler is below 2 μm, diffused lights interfere with each other and a rainbowing occurs, and contrast in the liquid crystal cell is lowered. In contrast, in the case in which it is above 15 μm, the visibility is deteriorated by blurring an edge portion of a liquid crystal image, and filler portions and blank portions of filler, that is, high portions of light difusivity and low portions thereof can be confirmed by visual observation and the uniformity is thereby deteriorated.

Furthermore, the impulsive force of pressure media must be uniformly transmitted to fillers, so that filling density of the filler layer in the planar direction is made highly uniform and embedding depths of fillers to the binding layer are also made uniform. Therefore, the particle diameter distribution of fillers is preferably 0.8 to 1.0, and is more preferably 0.9 to 1.0. In order to obtain a high light transparency, the refractive index of fillers is preferably 1.42 to 1.55, and in addition, the difference between refractive index of a base material and a binding layer and that of a filler is preferably 0.30 or less, and is more preferably 0.15 or less.

(4) Other Layers

Between a base material and a binding layer comprising the present invention, an adjustment layer for adjusting the refractive index or permeability of the light, a binding layer for firmly binding a base material and a binding layer, etc., may be provided as another layer.

B. Production Method

Next, a specific example of a production method for a filler lens according to the present invention is shown.

Process for Coating Binding Layer

The above adhesive is coated on one side or both sides of the above base material directly or via another layer by a coating method such as air doctor coating, blade coating, knife coating, reverse coating, transfer roll coating, photogravure roll coating, kiss coating, cast coating, spray coating, slot orifice coating, calender coating, electrodeposition coating, dip coatings, die coating, etc., or a printing method such as letterpress printing such as flexography, etc., intaglio printing such as direct gravure, offset gravure, etc., lithographic printing such as offset printing, etc., stencil printing such as screen printing, etc., or the like, and this is laminated as a binding layer. In particular, a coating using a roll coater is desirable because a uniform layer thickness is obtained. The thickness of the binding layer is preferably 0.5 to 2 times the volume average particle diameter of fillers to be embedded, and is more preferably 0.5 to 1.5 times thereof.

In the case in which the hardener component is included in the binding layer, in order to adjust embedding in the binding layer, it is preferable that the binding layer be protected by a separation PET film, etc.; it is aged at 20 to 80° C. for 3 to 14 days; the adhesive and the hardener are sufficiently reacted; and then the next process can be carried out.

Process for Adhering Fillers to Binding Layer

Next, fillers are adhered to the surface of the binding layer on the base material. As a specific method, for example, a method in which fillers filled in a container are fluidized by vibration or fluidization air and a base material is passed under this fluidized filler, and a method in which fillers are sprayed on the binding layer by air spraying, can be employed. At this time, since an organic filler has a higher fluidity than that of an inorganic filler, the organic fillers are easily mixed with air in the case of air spraying and are easily fluidized in the container. Therefore, such a filler is suitable for uniformly adhering to the surface of the binding layer. Defects such as falling out of filler can be reduced by uniformly adhering the fillers to the surface of the binding layer, and in the following process for embedding the fillers in the binding layer by pressure media, the pressure media can also be prevented from adhering to the binding layer. In this process, it is sufficient if only the fillers are adhered to the surface of the binding layer by adhesive strength of the binding layer.

Process for Embedding Fillers in Binding Layer

Fillers adhered to the surface of the binding layer are embedded in the binding layer by impulsive force of pressure media. As such a method, pressure media are put into a suitable container and are vibrated with the container, a base material in which fillers are adhered to the surface of a binding layer is put into this vibrated pressure media or is passed under this vibrated pressure media, and impulsive force is thereby imparted to the fillers. Thus, the fillers are struck by the pressure media and are thereby embedded in the surface of the binding layer. The pressure media is characterized in that the fillers can be embedded in the binding layer to a uniform embedding depth because the pressure media can be uniformly struck over a small area of the fillers. At this time, in case in which pressure media previously mixed with 0.5 to 2.0 parts by weight of fillers to 100 parts by weight of pressure media are used, filling density in the planar direction of the filler layer can be increased and be made uniform, since other fillers can be pushed into gaps between the fillers adhered on the surface of the binding layer in the above process to a uniform depth by impulsive force of the pressure media. According to such a method, fillers are formed as a filler layer in which the fillers are uniformly embedded in the binding layer at high density, as a monolayer, without the fillers piling up in the binding layer, so that embedding depths are made uniform and part of the filler protrudes from the binding layer.

As an external force for embedding fillers, in addition to vibration, rotation, falling, etc., may be adopted. In the case of rotation, a rotating container, a container having stirring fins therein, etc., can be used. In the case in which falling is adopted as an external force, a V blender, a tumbler, etc., can be used.

Hereinbelow, pressure media for embedding fillers are explained. The pressure media are particles to cause fillers to be embedded in a binding layer by striking due to vibration, etc., as described above. As a pressure medium, particles consisting of iron, carbon steel, alloy steel, copper and copper alloy, aluminum and aluminum alloy, and other various metals or alloys; particles consisting of ceramics such as Al₂O₃, SiO₂, TiO₂, ZrO₂, SiC, etc.; and in addition, particles consisting of glass, hard plastics, etc.; can be used. Furthermore, particles consisting of hard rubber may be used if a sufficient stroke force can be imparted to the fillers. In any case, material for the pressure medium is chosen appropriately depending on the material of the filler, etc. In addition, it is desirable that the shape thereof approximate a true sphere so that pressuring force is made uniform when applied to the fillers, and it is desirable that total particle distribution be as narrow as possible. The particle diameter of the pressure medium is chosen appropriately depending on the material and embedding depth of the filler, and in particular, it is preferably about 0.3 to 2.0 mm.

In order to prevent fillers from falling out from the binding layer and to reliably yield a lens effect by protruding the fillers from the surface of the binding layer, the embedding depth of fillers is preferably such that the fillers are embedded in the binding layer to a depth of 10 to 90% of the diameter, more preferably 30 to 90%, and most preferably 40 to 80%, and this can be adjusted depending on the optical properties of the lenses.

Process for Removing Surplus Fillers

After the embedding process of the fillers in the binding layer, surplus fillers are removed. Surplus fillers refer to, for example, fillers which are embedded imperfectly in the binding layer, or which only adhered on embedded fillers by interparticle forces such as electrostatic forces, van der Waals forces, etc. Such surplus fillers can be removed by washing in water or by applying fluidic pressure by air blasts, etc., to the filler layer. At this time, in the case in which the particle diameter of the filler is relatively small, it is desirable that the filler layer be wet washed using ion exchanged water, etc. In addition, in the case in which the particle diameter of the filler is even smaller, it is preferable that the filler layer be soaked in ion exchanged water to which is added a auxiliary washing agent such as a surfactant, etc., or the like, and be subjected to ultrasonic washing, etc., and then be rinsed sufficiently by ion exchanged water, etc., and be dried, since there is a risk that the surplus filler will be insufficiently removed by use of fluidic pressure alone.

In addition, in the case in which a process for softening a binding layer of a laminated film by heating or humidifying is carried out after the embedding process or this process, the fillers fit the binding layer well, and in particular, the total light transmittance and the reliability are thereby improved. Therefore, this process may be carried out as necessary. The process for softening may be carried out by only heating, or by heating and humidifying in combination.

Furthermore, the present inventors have conducted various research into shapes of a filler and surrounding states thereof in order to further improve optical properties of the filler lens, and have developed preferable embodiments according to the present invention in which more superior optical properties can be exhibited. In the following, constituent materials and production methods which is suitable for filler lenses according to the second to sixth embodiments of the present invention will be explained. The same compositions, constitutions, and production methods as in the first embodiment are omitted, and only specific points for each embodiment are described.

2. Second Embodiment

In a filler lens according to the second embodiment of the present invention, in order to sufficiently obtain uniform light diffusivity and light transparency, a filler layer is formed by an organic filler having a volume average particle diameter of 2 to 15 μm. Therefore, a filler lens according to the second embodiment of the present invention is characterized by comprising a base material, a binding layer provided on the base material directly or via another layer, and a filler layer consisting of many fillers embedded in the surface of the binding layer so that part of the filler protrudes from the surface thereof, wherein the filler layer comprises organic fillers having a volume average particle diameter of 2 to 15 μm.

A volume average particle diameter of this organic filler is preferably 2 to 15 μm, and is more preferably 2 to 10 μm. In the case in which the volume average particle diameter of the organic filler is below 2 μm, the contrast in a liquid crystal cell is deteriorated, since diffused light is interferes with each other and exhibits rainbowing. In contrast, in the case in which the particle diameter of the organic fillers is above 15 μm, diffused light becomes coarse, edge portions of liquid crystal images are blurred, and visibility is thereby deteriorated. Furthermore, in the case in which organic fillers having a volume average particle diameter above 15 μm are used, areas of fillers and areas of blanks in the fillers in the filler lens plane, that is, areas of light diffusing portions and areas of light non-diffusing portions increase together and they can be confirmed even by visual observation, and therefore, luminance nonuniformity is generated in the liquid crystal image.

In addition, since the narrower the particle diameter distribution of organic fillers, the more uniform the impulsive force transmitted from pressure media to organic fillers in the production method of the present invention, the embedding depths of the organic fillers in the binding layer can be made uniform. Additionally, for the same reason, the filling density in the planar direction of the organic fillers can also be made high and uniform. Therefore, in order to be made uniform, the impulsive force transmitted from the pressure media to the organic fillers, the particle diameter distribution of the organic fillers is preferably 0.8 to 1.0, and is more preferably 0.9 to 1.0.

In the present description, the “volume average particle diameter” is defined as follows, and the “particle diameter distribution” is defined by the following general equation.

Particle diameter distribution=Number average particle diameter/Volume average particle diameter

Number average particle diameter: An average value in which diameters of 100 organic fillers sampled at random from a photomicrograph of filler lens are measured and are averaged

Volume average particle diameter: A diameter of filler in the case in which sampled filler particles are regarded as being true spheres; diameters of 100 organic fillers sampled at random from a photomicrograph of filler lens are measured; each volume thereof is calculated by the measured diameters; total volume of the 100 organic fillers is summed for all calculated volumes; the calculated volumes are added up in order from the smallest volume; and the added value is reached at 50% of the above total volume.

At this time, in the case in which the organic filler particle is not a true sphere, the longest diameter thereof refers to a diameter of the organic filler.

In the present description, diameters of fillers were measured using photographs taken by a digital microscope (trade name: VH-6300; produced by Keyence Co., Ltd.) of transmitted light images of filler lenses.

3. Third Embodiment

In a filler lens according to the third embodiment of the present invention, in order to sufficiently obtain more uniform light diffusivity and light transparency, the standard deviation of interparticle distances of fillers in the planar direction of a filler layer is limited to 0.4 or less. Therefore, a filler lens according to the third embodiment of the present invention is characterized by comprising a base material, a binding layer provided on the base material directly or via another layer, and a filler layer consisting of many fillers embedded in the surface of the binding layer so that part of the filler protrudes from the surface thereof, wherein a standard deviation of interparticle distances of the fillers in the planar direction of the filler layer is 0.4 or less.

According to the third embodiment, the filling density of the fillers in the planar direction of the filler layer is high and uniform, and the light transparency and the light diffusivity in which are higher and more uniform than those of conventional filler lenses can thereby be exhibited. In the case in which the standard deviation of interparticle distances of the fillers in the planar direction of the filler layer is above 0.4, the light transparency is made nonuniform, and the light transparent property in practice cannot be sufficiently obtained.

The “interparticle distance of fillers” in the present invention is a value measured by the following method. Firstly, using photographs perpendicularly taken of the filler lenses from the planar direction, a filler is extracted as a standard point from the photograph at random. FIG. 4A is a schematic view of a photograph perpendicularly taken of a filler lens from the planar direction. In this figure, filler Y is a filler defined as a standard point for measuring a “interparticle distance of fillers”. Then, straight lines are drawn from the center of this filler Y as a standard point to all the centers of other adjoining fillers, and lengths of the straight lines are measured. Next, a value in which this length of the straight line is divided by the volume average particle diameter of the fillers (hereinafter referred to as volume average particle diameter X), will be referred to as the interparticle distance of the fillers.

Here, a filler in which the straight line comes in contact with another filler, a filler in which the particle diameter thereof is less than a half of the volume average particle diameter X, or a filler in which another filler overlaps therewith, are not referred to as another adjoining filler. In addition, a filler in which the particle diameter thereof is less than a half of the volume average particle diameter X, or a filler in which another filler overlaps therewith, are not referred to as a filler defined as a standard point. That is, in FIG. 4A, fillers Y1, Y2, Y4, and Y5 are other adjoining fillers. Filler Y3 is not another adjoining filler, since straight line x3 drawn from the center of filler Y as a standard point comes in contact with filler Y2. In addition, fillers Y6 and Y7 are not other adjoining fillers, since the diameters thereof are less than a half of the volume average particle diameter X of fillers. Furthermore, fillers Y8, Y9 and Y10 are not other adjoining fillers, since fillers overlap each other.

Therefore, “interparticle distances of fillers” to the filler Y as a standard point can be calculated by distances from the center of the filler Y as a standard point to each center of the fillers Y1, Y2, Y4, and Y5, and are the length of the straight line x1 divided by X, the length of the straight line x2 divided by X, the length of the straight line x4 divided by X, and the length of the straight line x5 divided by X.

Additionally, with respect to 30 fillers as standard points, “interparticle distances of fillers” are measured by the above measuring method, and a “standard deviation of interparticle distances of fillers” is calculated by these measured values. However, in the case in which the “interparticle distances of fillers” of the 30 fillers as standard points are measured, fillers which are specified once as a filler as a standard point and another adjoining filler and which is used to calculate “interparticle distances of fillers”, must not be specified again as a filler as a standard point and another adjoining filler. In addition, in the case in which a filler is not spherical as shown in FIG. 4B, a midpoint P of the longest diameter x11 of filler Y11 refers to as the center of the filler. In the present description, diameters of fillers were measured using photographs of transmitted light images in which filler lenses were taken at a magnification in which 50 to 100 fillers are projected on one photograph, using a digital microscope (trade name: VH-6300; produced by Keyence Co., Ltd.) as an apparatus for measuring the above interparticle distances of fillers.

4. Fourth Embodiment

In a filler lens according to the fourth embodiment of the present invention, in order to further improve the light diffusivity and the light uniformity, the protruding ratio of filler from a binding layer is limited to 50% or more, and the gel percentage of the binding layer is limited to 60% or more. Therefore, a filler lens according to the third embodiment of the present invention is characterized by comprising a base material, a binding layer provided on the base material directly or via another layer, and a filler layer consisting of many fillers embedded in the surface of the binding layer so that part of the filler protrudes from the surface thereof, wherein the binding layer has a gel percentage of 60% or more, and the protruding ratio of the filler is 50% or more.

According to the fourth embodiment of the present invention, by a specific production method, a filler layer 3A is formed as shown in FIG. 5A, so that fillers 3 are embedded at a high density in the planar direction and the protruding ratio of the filler 3 is 50% or more, sufficient light diffusion performance can be exhibited and superior contrast can be exhibited by restraining the native color of aluminum in the case in which it is used for a reflecting-type liquid crystal display.

For this purpose, it is necessary to contain a resin having a cross-linking point and a hardener in the binding layer of the fourth embodiment. In the case in which fillers are embedded in the surface of this binding layer, gel percentage of the binding layer sufficiently cross-linked is preferably 60% or more, is more preferably 70% or more, and is most preferably 80% or more. In the case in which the gel percentage of the binding layer is below 60%, since the binding layer is soft and the fillers are deeply embedded, the light diffusion performance by the fillers is not sufficiently exhibited. Furthermore, in this case, the environmental resistance (reliability) is inferior, in particular under high-temperature and high-humidity conditions, the light diffusivity is lowered since the binding layer softens and the fillers sink deeply in the binding layer.

A “gel percentage” in the present invention can be measured as follows.

\mathring{1} Weight A of a filler lens having a free diameter is measured.

\mathring{2} A binding layer of the filler lens is swelled by a solvent such as alcohol in which a base material of the filler lens is not eroded (for example, methanol, etc.), and then it is separated from the base material. As a separating method, for example, the binding layer may be scratched away by spatula, etc.

\mathring{3} Weight B of the base material separated from the binding layer is measured, and weight C of the binding layer is calculated by subtracting B from A.

\mathring{4} The binding layer separated from the base material is soaked in acetone for 24 hours under ordinary temperature and humidity conditions, and then it is stirred by an ultrasonic dispersion machine. In the acetone after stirring, a gel component of the binding layer and fillers contained in the binding layer have been mixed.

\mathring{5} In order to separate the gel component of the binding layer in the acetone from the fillers, a solution having of a specific gravity in which the fillers separate from the gel component (for example, chloroform, etc.), is added to the acetone, the fillers are precipitated, and in contrast, the gel component floats.

\mathring{6} Next, the gel component floated in the acetone is filtrated and dried, and weight D thereof is measured. In contrast, the fillers precipitated in the acetone are also filtrated and dried, and weight E thereof is measured.

\mathring{7} The “gel percentage” in the present invention can be calculated for each weight as obtained above using the following equation.

Gel percentage (%)=D/(C−E)×100

In order to avoid falling out of the fillers from the binding layer and to surely exhibit light diffusivity, it is necessary that the protruding ratio of filler from the binding layer be 50% or more. The protruding ratio of filler in the present invention is preferably 50 to 90%, is more preferably 55 to 80%, and is most preferably 60 to 80%. The protruding ratio of filler largely affects the light diffusion performance of fillers, and the light diffusion performance is remarkably lowered in the case in which the protruding ratio is below 50%. In contrast, in the case in which the protruding ratio is above 90%, the fillers easily fall out from the binding layer in the process for removing surplus fillers, etc.

The “protruding ratio of filler” in the present invention can be obtained by analyzing sectional photographs of filler layers, and it is an average of protruding ratios of 30 selected fillers.

In FIG. 5B, a schematic view of a sectional photograph in which fillers 3 are embedded so as to protrude from a binding layer 2 laminated on a base material 1 is shown. In order to obtain the protruding ratio of the filler, in FIG. 5B, a straight line is drawn between borders a and b of a filler 3 and a binding layer 2, and an intersection d between a center line c of the filler 3 and the above straight line is obtained. Next, a length Y from a tangent of the filler 3 to the intersection d is obtained, and a protruding ratio of one filler can be thereby calculated by the length Y and a diameter X of the filler 3, using the following equation.

Protruding ratio of one filler (%)=Y/X×100

Thus, protruding ratios of 30 fillers are calculated, and then the “protruding ratio of filler” in the present invention can be obtained by an average thereof.

Next, a suitable method for producing a filler lens of the above fourth embodiment, is explained.

This production method is characterized by comprising:

\mathring{1} a process for forming a binding layer on a base material directly or via another layer,

\mathring{2} a process for curing the binding layer so that the gel percentage is 60% or more,

\mathring{3} a process for embedding fillers in a surface of the binding layer by pressure media so that the protruding ratio of the filler is 50% or more, and

\mathring{4} a process for removing surplus fillers adhered to a laminated film formed above. At this time, it is preferable that a process for adhering fillers to the binding layer be carried out after the process \mathring{2}, and in addition, a process for drying using heat, etc., may also be carried out after the process \mathring{4}. By heating or humidifying, the fillers fit the binding layer well, and the light transparency is improved. At this time, humidifying may be carried out as necessary. In the following, specific processes in the fourth embodiment are explained.

Process for Curing Binding Layer

After a protective film such as separation PET film, etc., is adhered on the surface of the above binding layer, the binding layer is cured by being held under conditions of about 20 to 80° C. for 3 to 14 days, and the binding layer having a gel percentage of 60% or more is obtained. At this time, in the case in which a UV-curable adhesive is employed as a curable adhesive, the adhesive can also be cured by UV irradiation.

Process for Embedding Fillers in Binding Layer

A method for embedding fillers in the binding layer in the fourth embodiment is almost the same as in the first embodiment; however, the protruding ratio of fillers must be 50% or more.

5. Fifth Embodiment

In a filler lens according to the fifth embodiment of the present invention, in order to further improve the light transparency, a border between the surface of a binding layer and a filler, that is, an elevated portion of the binding layer is provided around the filler in the filler layer. Therefore, a filler lens according to the fifth embodiment of the present invention is characterized by comprising a base material, a binding layer provided on the base material directly or via another layer, and a filler layer consisting of many fillers embedded in the surface of the binding layer so that part of the filler protrudes from the surface thereof, wherein an elevated portion of the binding layer is provided around the filler in the filler layer.

According to the fifth embodiment of the present invention, by a specific production method, an elevated portion 2a is formed around a filler 3 on a binding layer 2 as shown in FIGS. 6A and 6B, so that the light transparency to the light transmitted from a base material side of a filler lens can be remarkably improved.

Next, a suitable method for producing a filler lens according to the above fifth embodiment is explained.

This production method is characterized by comprising:

\mathring{1} a process for forming a binding layer on a base material directly or via another layer,

\mathring{2} a process for embedding fillers in a surface of the binding layer by pressure media,

\mathring{3} a process for removing surplus fillers adhered to a laminated film formed above, and

\mathring{4} a process for softening the binding layer of the laminated film. At this time, it is preferable that a process for adhering fillers to the binding layer be carried out after the process \mathring{1}. In addition, the process \mathring{3} may also be carried out after the process \mathring{4}. By carrying out the process for softening the binding layer of the laminated film, an elevated portion can be provided around the filler.

Furthermore, in the case in which a filler lens according to the fifth embodiment of the present invention is produced, by selecting a resin having a small molecular weight or a resin having a low cross-linking density, as a resin for forming the binding layer, an elevated portion may be provided around the filler instead of the above process for softening the binding layer of the filler lens. However, in the case in which such a binding layer is used, the mechanical strength, such as scratch resistance of the filler layer, etc., is lowered, and in addition, crawling or peeling easily occurs in the adhesion layer when it is left under high-temperature and high-humidity conditions. In the following, a specific process in the fifth embodiment is explained.

Process for Softening Binding Layer of Laminated Film

The binding layer of the laminated film is softened. As a method for softening it, a method in which the binding layer is heated or humidified can be used. In order to soften the binding layer, the laminated film is left in a high temperature and high humidity oven, for example, at 30 to 80° C. and 60 to 95% RH, for 6 hours to 2 weeks, depending on a type of an adhesive or hardener which forms the binding layer. The process for softening may be carried out by only heating, or by heating and humidifying in combination.

In addition, the binding layer can also be softened, for example, by exposing the laminated film to a hot blast, an infrared ray heater, etc., or by irradiating it with electron beams, or the like, under conditions of 30 to 80° C. By softening the binding layer, an elevating portion is formed around the filler, and in particular, the light transparency from the film side can thereby be remarkably improved.

6. Sixth Embodiment

In a filler lens according to the sixth embodiment of the present invention, in order to stably maintain the reliability of the optical properties, that is, specific desired properties, a cure-controlled hardener is contained in a binding layer thereof and is appropriately cured. Therefore, a filler lens according to the sixth embodiment of the present invention is characterized by comprising a base material, a binding layer provided on the base material directly or via another layer, and a filler layer consisting of many fillers embedded in the surface of the binding layer so that part of the filler protrudes from the surface thereof, wherein the binding layer is cured by a cure-controlled hardener.

According to the sixth embodiment of the present invention, curing of the coating solution in formation of the binding layer or curing of the binding layer from formation thereof to embedding of fillers can be avoided, and the degree of embedding of the fillers can thereby be easily adjusted. Furthermore, by curing the binding layer after embedding the fillers, the thermal fluidity of the adhesive does not occur even if the filler lens is left under high-temperature and high-humidity conditions, and the degree of embedding of the fillers, that is, the optical property, can be stably maintained.

In addition, in the sixth embodiment, the curing temperature cannot be greatly increased in the case in which a plastic film is used as a base material. In particular, in the case in which PET or TAC is used, it is desirable that resin which can be cured at 100° C. or less be used in the binding layer.

Furthermore, it is necessary that a cure-controlled hardener be employed in this binding layer, as an essential component. As the cure-controlled hardener, blocked hardeners, capsulated hardeners, etc., can be employed, in which functional groups which contributes to curing do not react at room temperature (ordinary temperature to about 60° C.). The hardeners initially function, for example, by heating above a specific temperature. Specifically, as an isocyanate-type hardener, blocked isocyanate compounds in which the isocyanate group is blocked (masked) by suitable active hydrogen compound (hereinafter referred to as a “blocking agent”) such as alcohols, phenols, lactams, oximes etc., can be employed. This blocked isocyanate compound can be prepared by the following method: firstly, polyisocyanate is added in a reactor having a stirrer, a thermometer, and a reflux condenser, then blocking agent is added thereto during stirring, and blocking reaction is carried out by heating to 70 to 80° C.

As a blocking agent, ethyleneglycol monobutylether, diethyleneglycol monobutylether, triethyleneglycol monobutylether, tetraethyleneglycol monobutylether, pentaethyleneglycol monobutylether, ethyleneglycol monohexylether, diethyleneglycol monohexylether, ethyleneglycol mono-2-ethylhexylether, diethyleneglycol mono-2-ethylether, propyleneglycol monomethylether, dipropyleneglycol monomethylether, allyl alcohol, hydroxy acrylate compound such as 2-hydroxy ethylacrylate, 2-hydroxy propylacrylate, 2-hydroxy ethylmethacrylate, etc., active methylene compound having a double bond such as such allyl acetoacetate, diallyl malonate, etc., or the like, can be employed. Of these agents, agents having a boiling point which is higher than a curing temperature thereof is preferred, since it can prevent problems, such as foaming in a coating film, etc., from occurring when it is cured.

As a isocyanate for forming the blocked isocyanate compounds, diisocyanates such as 2,4-tolylene diisocyanate, 2,6-tolylene diisocyanate, 2,2′-diphenylmethane diisocyanate, 2,4′-diphenylmethane diisocyanate, xylene diisocyanate, phenylene diisocyanate, hexamethylene diisocyanate, isophorone diisocyanate, tolylene diisocyanate hydride, diphenylmethane diisocyanate hydride, xylene diisocyanate hydride, monomethyl hexamethylene diisocyanate, trimethyl hexamethylene diisocyanate, lysine isocyanate, dodecamethylene diisocyanate, etc., urethane compounds of these diisocyanates, burette compounds thereof, isocyanurate compounds (trimer) thereof, carbodiimide compounds thereof, and polymers thereof, can be employed. These compounds can be used alone or in combination.

In the present embodiment, it is preferable in practice that adhesion of the binding layer before curing (180 degree peel adhesion according to Japanese Industrial Standard Z-0237) be 50 to 3000 g/25 mm and the adhesion thereof after curing be 30 g/25 mm or less. In the case in which the adhesion thereof before curing is below 50 g/25 mm, it is difficult to embed fillers or embedded fillers often fall out. In contrast, in the case in which it is above 3000 g/25 mm, fillers are embedded too deeply or the surface of the filler layer is easily damaged and indented. In addition, in the case in which the adhesion thereof after curing is above 30 g/25 mm, the surface of the filler layer is easily damaged and indented, or the environmental resistance is inferior, in particular, there is a risk that the optical properties change at high temperatures and high humidity.

Next, a suitable method for producing a filler lens according the above sixth embodiment is explained.

This production method is characterized by comprising:

\mathring{1} process for forming a binding layer on a base material directly or via another layer,

\mathring{2} a process for embedding fillers in a surface of the binding layer by pressure media,

\mathring{3} a process for curing the binding layer, and

\mathring{4} a process for removing surplus fillers adhered to a laminated film formed above. At this time, it is preferable that a process for adhering fillers to the binding layer be carried out before the process \mathring{2}, since defects on the outside such as falling out of fillers, etc., can be decreased and embedding of fillers can be surely carried out. In the following, specific processes in the sixth embodiment are explained.

Process for Curing Binding Layer

An adhesive of the binding layer embedding the fillers is cured by heating. Until the above process for embedding fillers, it is desirable that the adhesive be soft and the embedding depth of fillers be easily controlled. However, after the fillers are embedded, in order to maintain the optical properties of the filler lens, the adhesive must be cured so that thermal flow does not occur even under high temperatures and high humidity.

### BRIEF DESCRIPTION OF THE DRAWINGS

FIG. 1 shows a sectional schematic view of an example of a filler lens according to the present invention.

FIG. 2 shows a sectional schematic view of an example of a conventional filler lens.

FIG. 3 is photomicrographs of a filler lens produced by pressure rollers. FIG. 3A shows an optical photomicrograph of a plane view of a filler lens at a magnification of 10×, and FIG. 3B shows an electron photomicrograph of a sectional view of a filler lens at a magnification of 2,000×.

FIG. 4 shows a sectional schematic view for explaining interparticle distances of fillers. FIG. 4A shows a schematic view of a photograph perpendicularly taken of a filler lens from a planar direction, and FIG. 4B shows a schematic view in the case in which fillers are not spherical.

FIG. 5A shows a sectional schematic view of a filler lens according to a fourth embodiment of the present invention, and FIG. 5B shows a schematic view which explains a method for calculating the ratio by which a filler protrudes from a binding layer.

FIG. 6A shows a sectional schematic view of a filler lens according to a fifth embodiment of the present invention, and FIG. 6B shows an enlarged view around the filler.

FIG. 7 shows a front sectional view of an excitation apparatus which is suitable for a production method of the present invention.

FIGS. 8A, 8B, and 8C show electron photomicrographs of a plane view of a filler lens of Sample 1-1 of the present invention at magnifications of 1,000×, 2,000×, and 5,000×, respectively.

FIGS. 9A, and 9B show electron photomicrographs of a sectional view of a filler lens of Sample 1-1 of the present invention at magnifications of 2,000×, and 5,000×, respectively.

FIGS. 10A, 10B, and 10C show electron photomicrographs of a plane view of a filler lens of Sample 1-2 of the present invention at magnifications of 1,000×, 2,000×, and 5,000×, respectively.

FIGS. 11A, and 11B show electron photomicrographs of a sectional view of a filler lens of Sample 1-2 of the present invention at magnifications of 2,000×, and 5,000×, respectively.

FIGS. 12A and 12B show diagrams for explaining the cases in which the light was transmitted from the film side to a filler lens and from the filler side to a filler lens, respectively

FIGS. 13A and 13B show diagrams of measuring methods of total light diffusion transmittance and total light diffusion reflectance for explaining a measuring method of light diffusivity, respectively.

FIGS. 14A and 14B show electron photomicrographs of a plane view and a sectional view of a filler lens of Sample 2-1 according to the present invention at a magnification of 1,000×, respectively.

FIGS. 15A and 15B show electron photomicrographs of a plane view and a sectional view of a filler lens of Sample 2-2 according to the present invention at a magnification of 1,000×, respectively.

FIGS. 16A and 16B show electron photomicrographs of a plane view and a sectional view of a filler lens of Sample 2-3 according to the present invention at a magnification of 1,000×, respectively.

FIGS. 17A and 17B show electron photomicrographs of a plane view and a sectional view of a filler lens of Sample 2-4 according to the present invention at a magnification of 1,000×, respectively.

FIGS. 18A and 18B show electron photomicrographs of a plane view and a sectional view of a filler lens of Sample 2-5 according to the present invention at a magnification of 1,000×, respectively.

FIGS. 19A and 19B show electron photomicrographs of a plane view and a sectional view of a filler lens of Sample 2-6 for comparing at a magnification of 1,000×, respectively.

FIGS. 20A and 20B show electron photomicrographs of a plane view and a sectional view of a filler lens of Sample 2-7 for comparing at a magnification of 1,000×, respectively.

FIGS. 21A and 21B show electron photomicrographs of a plane view and a sectional view of a filler lens of Sample 2-8 for comparing at a magnification of 1,000×, respectively.

FIGS. 22A and 22B show electron photomicrographs of a plane view and a sectional view of a filler lens of Sample 3-1 according to the present invention at a magnification of 1,000×, respectively.

FIGS. 23A and 23B show electron photomicrographs of a plane view and a sectional view of a filler lens of Sample 3-2 according to the present invention at a magnification of 500×, respectively.

FIGS. 24A and 24B show electron photomicrographs of a plane view and a sectional view of a filler lens of Sample 3-3 according to the present invention at a magnification of 500×, respectively.

FIGS. 25A1 and 25A2 show electron photomicrographs of a dense region and a coarse region in a plane view of a filler lens of Sample 3-4 for comparing at a magnification of 1,000×, respectively. FIG. 25B shows an electron photomicrograph of a sectional view of a filler lens of Sample 3-4 for comparing at a magnification of 1,000×.

FIGS. 26A1 and 26A2 show electron photomicrographs of a dense region and a coarse region in a plane view of a filler lens of Sample 3-5 for comparing at a magnification of 1,000×, respectively. FIG. 26B shows an electron photomicrograph of a sectional view of a filler lens of Sample 3-5 for comparing at a magnification of 1,000×.

FIGS. 27 shows an electron photomicrograph of a plane view of a filler lens of Sample 3-6 for comparing at a magnification of 500×.

FIGS. 28 shows an electron photomicrograph of a plane view of a filler lens of Sample 3-7 for comparing at a magnification of 500×.

FIGS. 29A and 29B show electron photomicrographs of a plane view and a sectional view of a filler lens of Sample 3-8 for comparing at a magnification of 1,000×, respectively.

FIGS. 30A and 30B show optical photomicrographs of plane views of filler lenses of Sample 3-1 according to the present invention and Sample 3-4 for comparing, respectively, which are taken at a magnification of 50×using transmitted light.

FIGS. 31A and 31B show electron photomicrographs of a plane view and a sectional view of a filler lens of Sample 4-1 according to the present invention at a magnification of 2,000×, respectively.

FIGS. 32A and 32B show electron photomicrographs of a plane view and a sectional view of a filler lens of Sample 4-2 according to the present invention at a magnification of 2,000×, respectively.

FIGS. 33A and 33B show electron photomicrographs of a plane view and a sectional view of a filler lens of Sample 4-3 for comparing at a magnification of 2,000×, respectively.

FIGS. 34A and 34B show electron photomicrographs of a plane view and a sectional view of a filler lens of Sample 4-4 for comparing at a magnification of 2,000×, respectively.

FIGS. 35A and 35B show electron photomicrographs of a plane view and a sectional view of a filler lens of Sample 5-1 according to the present invention at a magnification of 5,000×, respectively.

FIGS. 36A and 36B show electron photomicrographs of a plane view and a sectional view of a filler lens of Sample 5-2 according to the present invention at a magnification of 5,000×, respectively.

FIGS. 37A and 37B show electron photomicrographs of a plane view and a sectional view of a filler lens of Sample 5-3 for comparing at a magnification of 5,000×, respectively.

FIG. 38 shows a sectional schematic view of an example in which a filler lens of the present invention is applied to a transmitting type of liquid crystal display.

FIG. 39 shows a sectional schematic view of an example in which a filler lens of the present invention is applied to a reflecting type of liquid crystal display.

FIG. 40 shows a sectional schematic view of an example in which a filler lens of the present invention is applied to a liquid crystal display as a light diffusion lens.

### BEST MODE FOR CARRYING OUT THE INVENTION

Next, the present invention will be more specifically explained by examples. Hereinafter, “parts” refers to “parts by weight”.

1. First Embodiment

(1) Production of Filler Lens

Sample 1-1

As a transparent base material, a triacetyl cellulose film having a thickness of 80 μm (trade name: Fuji TAC UVD80; produced by Fuji Photo Film Co., Ltd.; refractive index 1.49) was used. An adhesive in which 1.5 parts by weight of isocyanate-type hardener (trade name: D-90; produced by Soken Chemical & Engineering Co., Ltd.; total solid concentration in ethylacetate of 90%) was added to 100 parts by weight of acrylic adhesive (trade name: SK Dain 881L; produced by Soken Chemical & Engineering Co., Ltd.; total solid concentration in ethylacetate of 23%), was coated on one side of the transparent base material by a reverse coater, so as to have a thickness of 10 μm after drying, and was dried at 100° C. for 2 minutes, and a binding layer was formed.

Next, an acrylic-type filler, consisting polymethylmethacrylate having a monodispersive particle diameter of 5 μm and refractive index of 1.50, was employed as a filler, and these fillers were put into a porous plate container from which air was jetted from the bottom. Subsequently, this container was vibrated, and the fillers were caused to flow by synergistic effects of the vibration and the jetted air. The above film provided with a binding layer on the surface was passed therethrough for an appropriate period, and the fillers were thereby adhered on the surface of the binding layer.

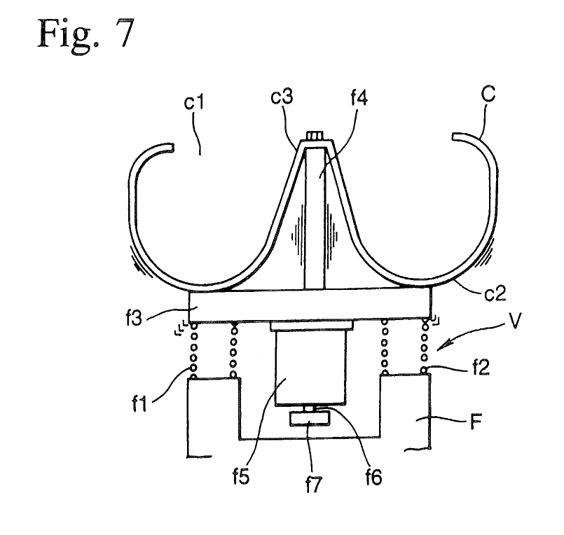

Then, the fillers were embedded in the surface of the binding layer by an excitation apparatus shown in FIG. 7, and a filler layer was thereby formed. According to this excitation apparatus, pressure media, fillers, and the above film were put into a container C set on an excitation mechanism V, these were vibrated with the container C by the excitation mechanism V, and the fillers were thereby embedded in the binding layer of the film.

The container C consists of hard materials such as hard synthetic resin, metal, etc., and is formed in a bowl shape having an opening c1 at the upper portion thereof. A column portion c3 is protrudingly provided in the center of a bottom portion c2 so as to swell and protrude above and to reach the same height as the opening c1. The excitation mechanism V is composed as follows: a vibrating plate f3 is mounted on machine stand F by way of coil springs f1 and f2; a vertical axis f4 extending above to the center portion of an upper surface of the vibrating plate f3 is protrudingly provided; a motor f5 is fixed at the center of a lower surface of the vibrating plate f3; and a heavy weight f7 is attached eccentrically to this output shaft f6 of the motor f5. The container C is mounted on the vibrating plate f3 and is set by fixing the upper edge of the column c3 on the upper edge of the vertical axis f4, and then the container C is vibrated when the motor f5 is driven and the heavy weight f7 rotates.

3 kg of perfectly globular zirconia particles having a particle diameter of 0.5 mm was put into the container C of this excitation apparatus as a pressure medium, 30 g of the above filler was further added thereinto, and both were mixed. Next, in the excitation apparatus, while the container C was vibrated in the state in which the container C shown in FIG. 7 was inclined at 45 degrees, and the above film was passed through the pressure media by moving the bottom of the container C at a speed of 30 cm/min, so that the side of the binding layer to which the fillers adhered were turned up. Thus, the fillers were embedded in a surface of the binding layer by being struck due to the vibrating pressure medium, and a filler layer was thereby formed.

Subsequently, the filler layer was washed by a hydraulic shower of ion exchanged water and the surplus fillers were thereby removed. Subsequently, the entire film was dried by blowing air, and a filler lens of Sample 1-1 according to the present invention was thereby formed.

Sample 1-2

A filler lens of Sample 1-2 according to the present invention was formed in the same manner as for Sample 1-1 except that fillers having a volume average particle diameter of 15 μm and pressure media having a particle diameter of 1.0 mm were employed.

Sample 1-3

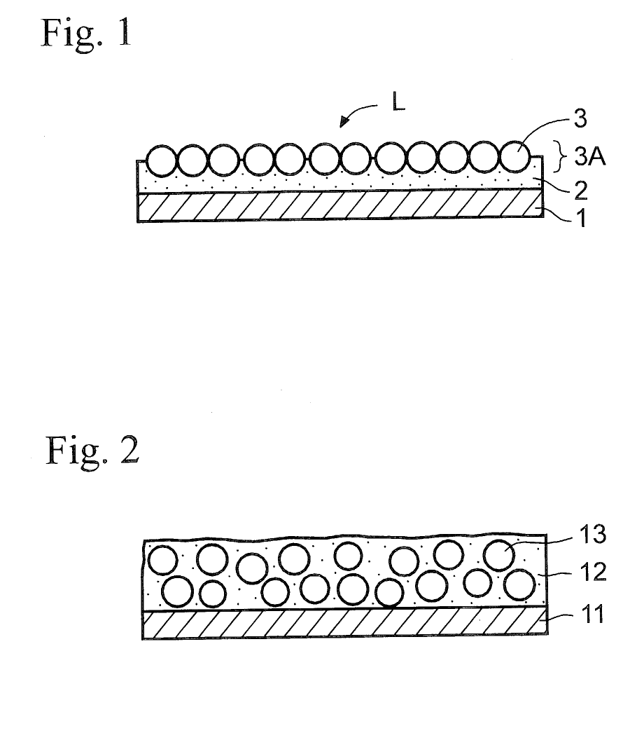

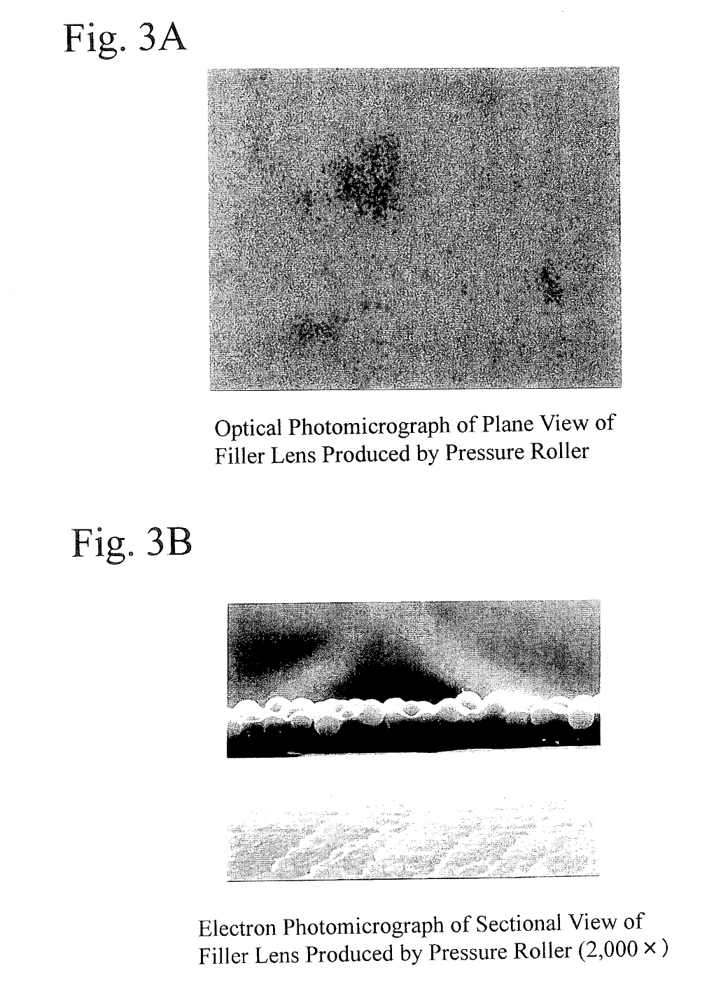

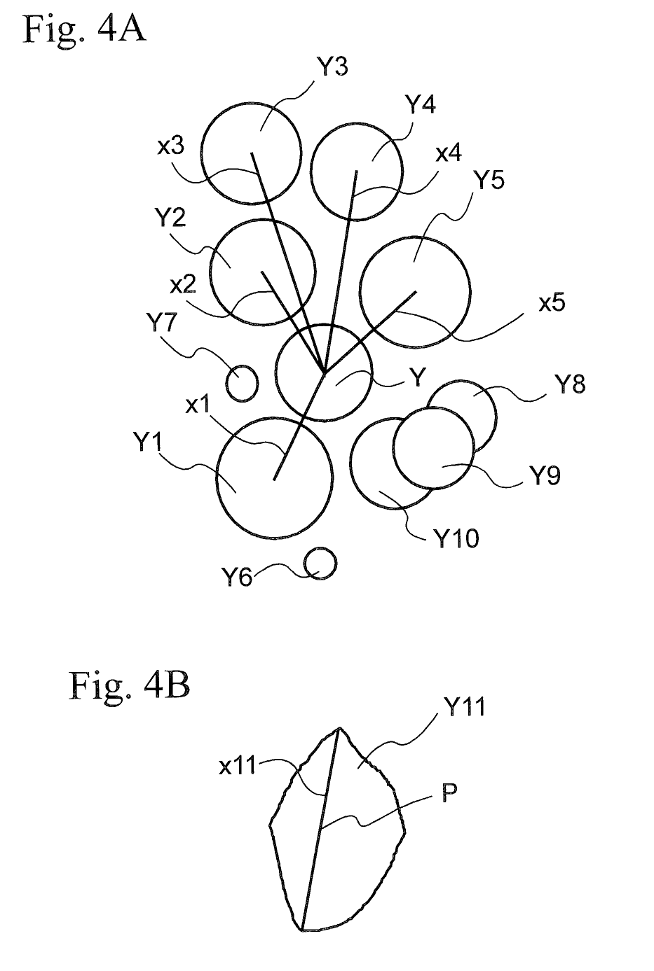

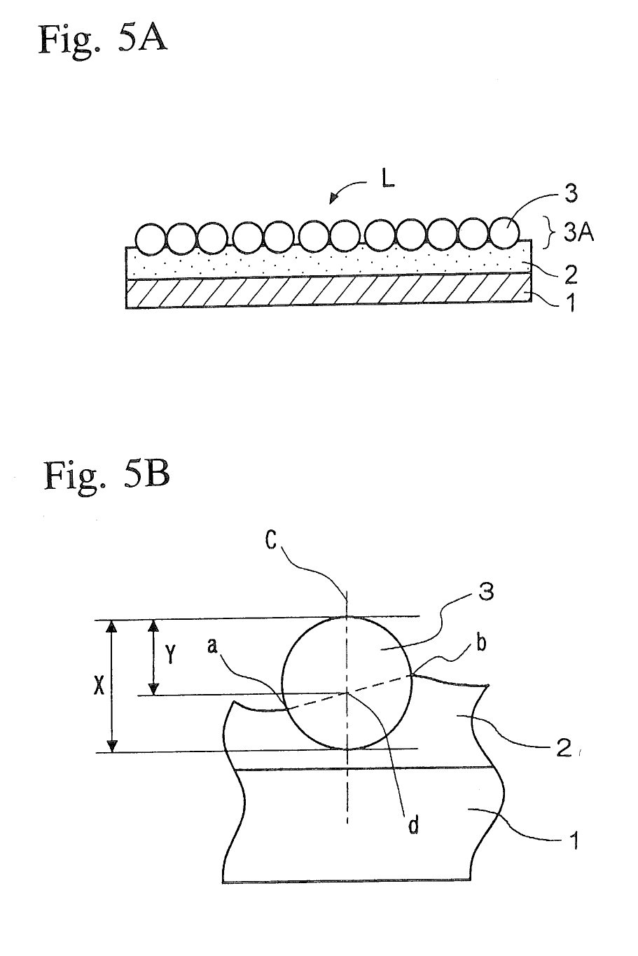

A coating solution, obtained by dispersing a mixture consisting of the composition below for 30 minutes using a sand mill, was coated on one surface of triacetyl cellulose (trade name: Fuji TAC UVD80; produced by Fuji Photo Film Co., Ltd.; refractive index 1.49) which is a transparent base material having a film thickness of 80 μm, and a transmittance of 92%, by a reverse coating method, and this was then dried for 2 minutes at 100° C. Subsequently, the film was exposed to UV radiation to cure the coating film, under the conditions of output power: 120 W/cm; source distance: 10 cm; and exposure time: 30 seconds; using one converging type high-pressure mercury lamp. Thus, a conventional filler lens of Sample 1-3 as shown in FIG. 2 was formed as a comparative example of the present embodiment. Composition of Coating Solution

Epoxy acrylic-type UV curable resin (trade name: KR-566; produced by Asahi Denka Kogyo K. K.; total solid concentration of 95%), 95 parts by weight

Closslinked acrylic bead pigment (trade name: MX150; produced by Soken Chemical & Engineering Co., Ltd.; particle diameter 1.5 μm±0.5), 10 parts by weight

Isopropyl alcohol, 230 parts by weight

(2) Evaluation of Filler Lens

\mathring{1} Observation of Filler Layer

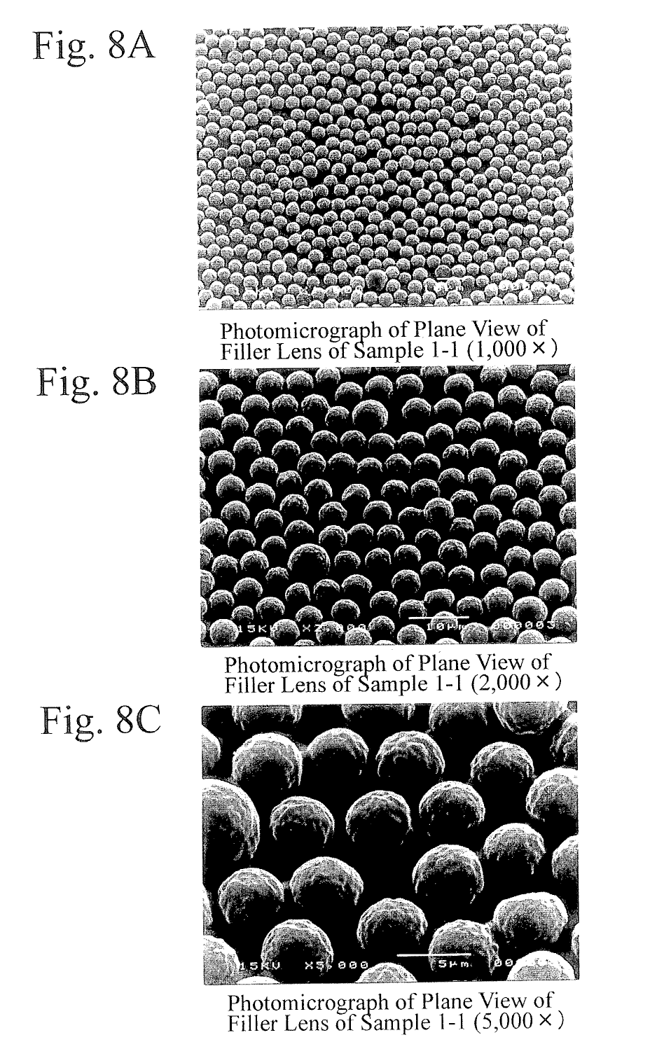

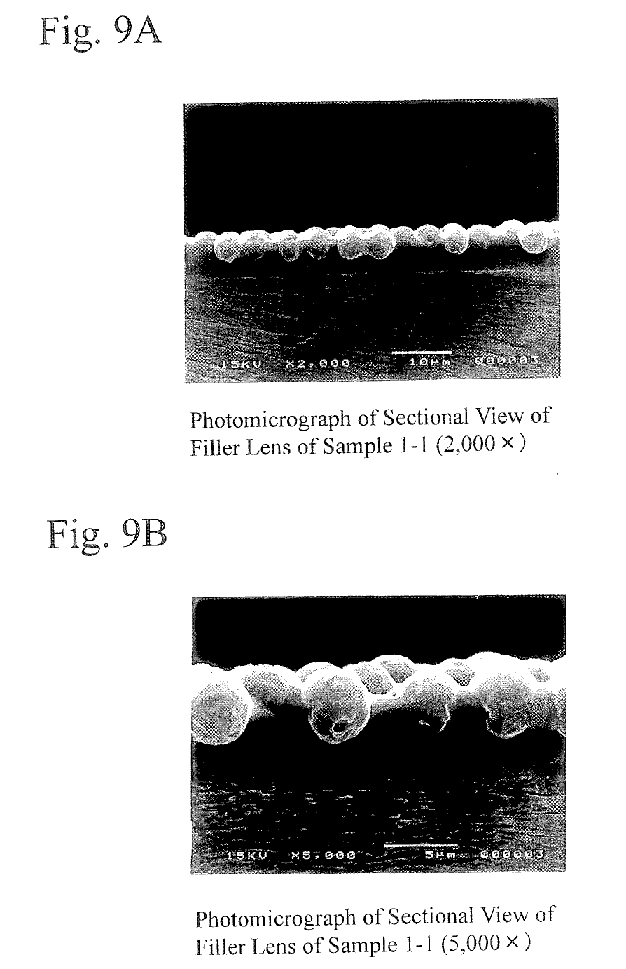

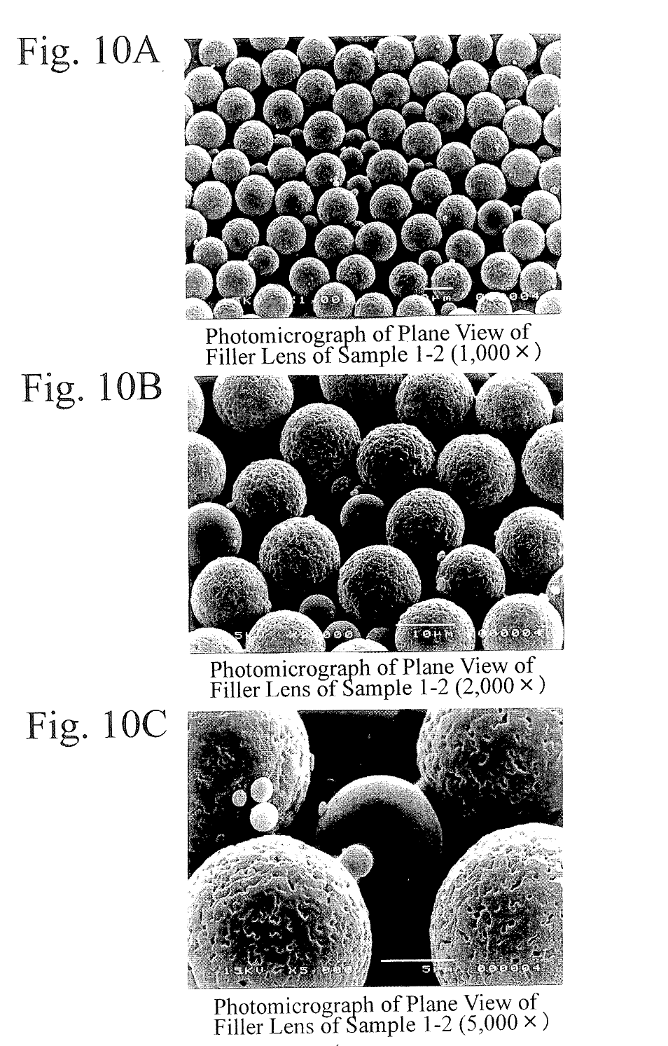

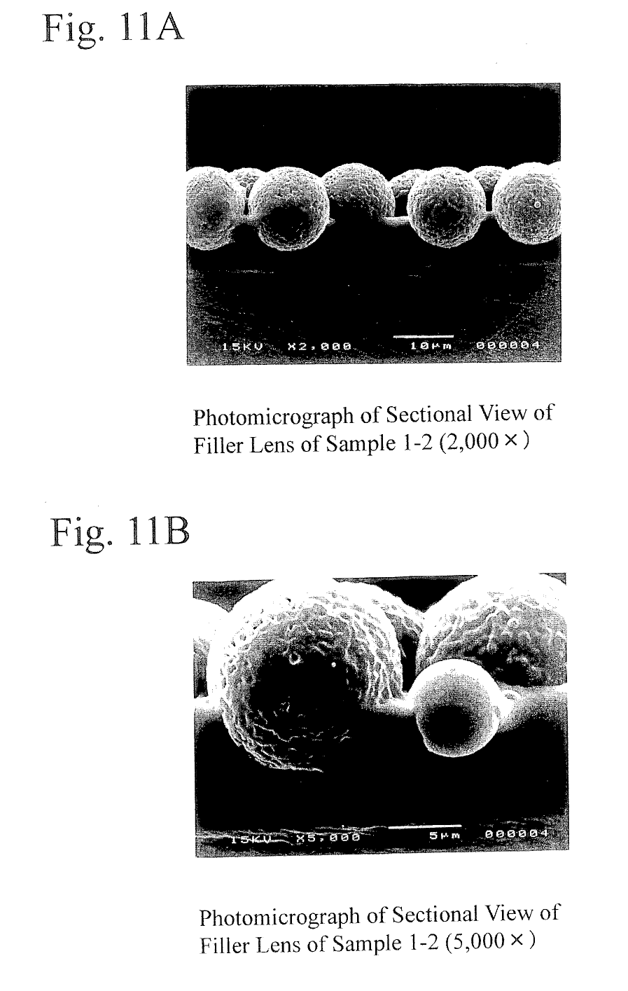

Plane views and sectional views of the filler lenses of Samples 1-1 and 1-2 were observed by an electron microscope. FIGS. 8A, 8B, and 8C show electron photomicrographs of a plane view of a filler lens of Sample 1-1 at magnifications of 1,000×, 2,000×, and 5,000×, respectively. FIGS. 9A and 9B show electron photomicrographs of a sectional view of a filler lens of Sample 1-1 at magnifications of 2,000× and 5,000×, respectively. FIGS. 10A, 10B, and 10C show electron photomicrographs of a plane view of a filler lens of Sample 1-2 at magnifications of 1,000×, 2,000×, and 5,000×, respectively. FIGS. 11A and 11B show electron photomicrographs of a sectional view of a filler lens of Sample 1-2 at magnifications of 2,000× and 5,000×, respectively. As is apparent from the plane photomicrographs, fillers had been uniformly dispersed at a high density in both filler lenses of Samples 1-1 and 1-2. In addition, as is apparent from the sectional photomicrographs, the fillers of Samples 1-1 and 1-2 uniformly protruded from the surface of the binding layer, so that the fillers were embedded at depths of about 70% and 40% of the diameters thereof, respectively, in the binding layer.

\mathring{2} Light Diffusivity Test

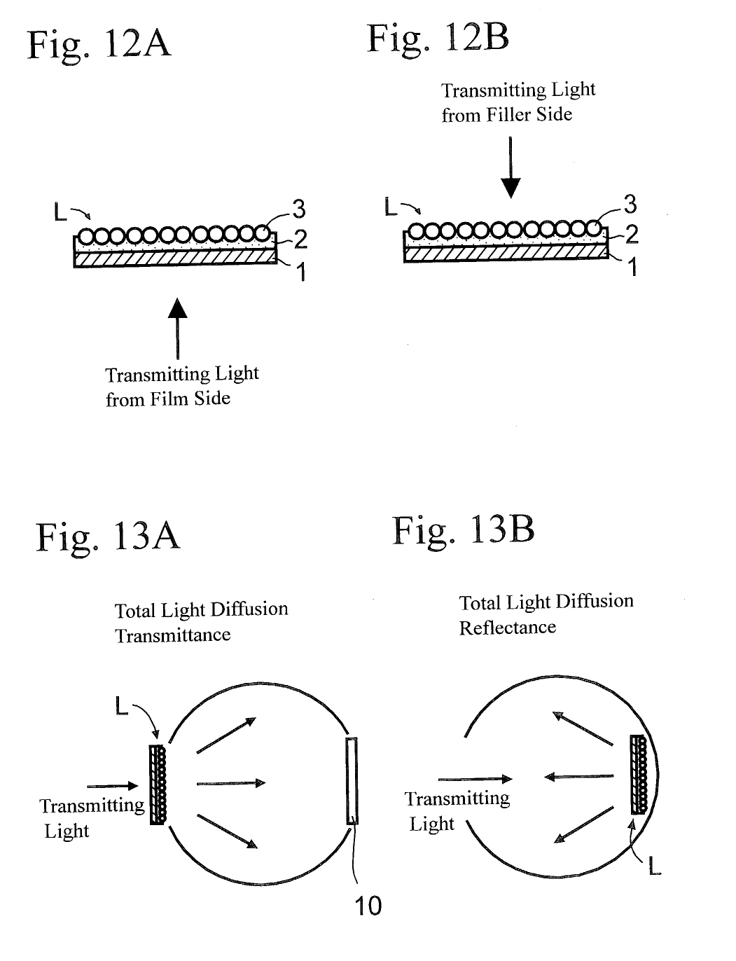

With respect to the above filler lenses of Samples 1-1 to 1-3, total light diffusion transmittance: T % and total light diffusion reflectance: R % in the cases in which the light was transmitted from the film 1 side as shown in FIG. 12A and in which the light was transmitted from the filler 3 side as shown in FIG. 12B, were measured using a spectrophotometer UV3100 produced by Shimadzu Corporation.

As a measuring method of total light diffusion transmittance: T %, a filler lens was placed between incident light and a standard white board (magnesium sulfate) 10 as shown in FIG. 13A and then the total light diffusion transmittance of light diffused forward was measured. FIG. 13B shows the case in which light is transmitted from the film side as shown in FIG. 12A; however, also with respect to the case in which light is transmitted from the filler side as shown in FIG. 12B, total light diffusion transmittance was measured in the same way.

Furthermore, as a measuring method of total light diffusion reflectance: R %, first, light is transmitted on a standard white board (magnesium sulfate), then, total light diffusion reflectance of light diffused backward is measured, and the measured value is defined as 100. Secondly, total light diffusion reflectance thereof is measured by emitting light to a filler lens L as shown in FIG. 13B and then, it is calculated as a ratio of the total light diffusion reflectance of the above standard white board. FIG. 13B shows the case in which light is transmitted from the film side as shown in FIG. 12A; however, also with respect to the case in which light is transmitted from the filler side as shown in FIG. 12B, total light diffusion reflectance was measured in the same way. In this case, the measured wavelength was in a range of 400 to 700 nm, and the measured value is shown by the average value in this wavelength range. The results are shown in Table 1.

TABLE 1

| | Light Transmitting from | | Light Transmitting from | |
|---|---|---|---|---|
| | Film Side | | Filler Side | |
| | T % | R % | T % | R % |
| Sample 1-1 | 62.2 | 45.3 | 99.8 | 24.8 |
| Sample 1-2 | 70.3 | 42.3 | 97.6 | 28.3 |
| Sample 1-3 | 91.3 | 26.7 | 91.4 | 26.5 |

As shown in Table 1, in Sample 1-3, in the case in which light was transmitted from either the film side or the filler side, total light diffusion transmittance was about 91% and total light diffusion reflectance was about 26%, and there was no difference. In contrast, with respect to light diffusivities of Samples 1-1, and 1-2, there were differences between light transmitting directions from the film side and from the filler side. In the case in which light was transmitted from the film side, total light diffusion transmittance was lower than in Sample 1-3 and total light diffusion reflectance was higher. In contrast, in the case in which light was transmitted from the filler side, total light diffusion transmittance was extremely high and total light diffusion reflectance was low. That is, according to a filler lens of the present invention, a lens effect can be obtained in which light diffusivities are different depending on the light transmitting direction. Optical properties corresponding to various purposes can be obtained by using this lens effect.

2. Second Embodiment

(1) Production of Filler Lens

Firstly, an acrylic polymer “a” employed as an adhesive in a binding layer of the second embodiment according to the present invention, is explained.

94 parts by weight of n-butyl acrylate, 3 parts by weight of acrylic acid, 1 weight part of 2-hydroxy acrylate, 0.3 parts by weight of benzoyl peroxide, 40 weight parts of ethyl acetate, and 60 parts by weight of toluene were added to a flask having a thermometer, a stirrer, a reflux condenser, and a nitrogen feeding tube. The flask was filled with nitrogen by feeding nitrogen thereinto through the nitrogen feeding tube, and was heated to 65° C., and the polymerization reaction was allowed to proceed for 10 hours. An acrylic polymer solution having a weight average molecular weight of about 1,000,000 and a Tg of about −50° C. was thereby obtained. Subsequently, methyl isobutyl ketone was added in this acrylic polymer solution so that a solid concentration thereof was 20% by weight, and therefore, an acrylic polymer “a” was prepared and was employed in the following filler lenses.

Sample 2-1

As a transparent base material, a triacetyl cellulose film having a thickness of 80 μm (trade name: Fuji TAC UVD80; produced by Fuji Photo Film Co., Ltd.; refractive index 1.49; total light transmittance 92.4) was used. An adhesive in which 0.2 parts by weight of isocyanate-type hardener (trade name: L-45; produced by Soken Chemical & Engineering Co., Ltd.) and 0.1 parts by weight of epoxy-type hardener (trade name: E-5XM; produced by Soken Chemical & Engineering Co., Ltd.) were added to 100 parts by weight of acrylic polymer “a”, was coated on one side of this TAC film by a reverse coater, so as to have a thickness of 3 μm after drying, and was dried at 100° C. for 2 minutes, and a binding layer was formed. Then, this film was cut to A5 size.

Next, methylsilicone beads (trade name: Tospearl 145; produced by GE Toshiba Silicone Co., Ltd.) having a volume average particle diameter of 4.5 μm, particle diameter distributions of 0.94, refractive index of 1.43, and roundness of 96%, used as an organic filler, were put into a porous plate container from which air was jetted from the bottom. Subsequently, this container was vibrated, and the organic fillers were flowed by synergistic effects of the vibration and the jetted air. The above film provided with a binding layer on the surface was passed therethrough for an appropriate period, and the fillers were thereby adhered on the surface of the binding layer.

Then, the organic fillers were embedded in the surface of the binding layer in the same manner as in the above first embodiment. Subsequently, the surplus fillers were washed away and removed by soaking the laminated film in 0.1% aqueous solution in which surfactant (trade name: Liponox NC-95; produced by Lion Corporation) was added to ion exchanged water and by using ultrasonic waves. Next, the film was pulled out of the solution and was sufficiently washed by ion exchanged water, and then water was drained off the surface thereof by an air knife and was dried. Subsequently, the film was sufficiently dried by being left in a constant temperature oven at 40° C. for 5 days and was cooled at room temperature, and a filler lens of Sample 2-1 of the present invention was thereby formed.

Sample 2-2

The same adhesive as that of Sample 2-1 was coated on one side of the same film as that of Sample 2-1 by a reverse coater, so as to have a thickness of 3 μm after drying, and was dried at 100° C. for 2 minutes, and a binding layer was formed. Then, this film was cut to A5 size. The following processes were carried out in the same manner as for Sample 2-1 except that methylsilicone beads (trade name: Tospearl 130; produced by GE Toshiba Silicone Co., Ltd.) having a volume average particle diameter of 2.6 μm, refractive index of 1.43, particle diameter distributions of 0.90, and roundness of 94%, were used as an organic filler, and a filler lens of Sample 2-2 of the present invention was thereby formed.

Sample 2-3

The same adhesive as that of Sample 2-1 was coated on one side of the same film as that of Sample 2-1 by a reverse coater, so as to have a thickness of 4 μm after drying, and was dried at 100° C. for 2 minutes, and a binding layer was formed. Then, this film was cut to A5 size. The following processes were carried out in the same manner as for Sample 2-1 except that methylmethacrylate beads (trade name: MX-500; produced by Soken Chemical & Engineering Co., Ltd.) having a volume average particle diameter of 5.0 μm, refractive index of 1.50, particle diameter distributions of 0.94, and roundness of 93%, were used as an organic filler, and a filler lens of Sample 2-3 of the present invention was thereby formed.

Sample 2-4

The same adhesive as that of Sample 2-1 was coated on one side of the same film as that of Sample 2-1 by a reverse coater, so as to have a thickness of 5 μm after drying, and was dried at 100° C. for 2 minutes, and a binding layer was formed. Then, this film was cut to A5 size. The following processes were carried out in the same manner as for Sample 2-1 except that methylmethacrylate beads (trade name: MX-500; produced by Soken Chemical & Engineering Co., Ltd.) having a volume average particle diameter of 10.8 μm, refractive index of 1.50, particle diameter distributions of 0.94, and roundness of 94%, were used as an organic filler, and a filler lens of Sample 2-4 of the present invention was thereby formed.

Sample 2-5

The same adhesive as that of Sample 2-1 was coated on one side of the same film as that of Sample 2-1 by a reverse coater, so as to have a thickness of 6 μm after drying, and was dried at 100° C. for 2 minutes, and a binding layer was formed. Then, this film was cut to A5 size. The following processes were carried out in the same manner as for Sample 2-1 except that methylmethacrylate beads (trade name: MX-1500H; produced by Soken Chemical & Engineering Co., Ltd.) having a volume average particle diameter of 14.9 μm, refractive index of 1.50, particle diameter distributions of 0.96, and roundness of 92%, were used as an organic filler, and a filler lens of Sample 2-5 of the present invention was thereby formed.

Sample 2-6

The same adhesive as that of Sample 2-1 was coated on one side of the same film as that of Sample 2-1 by a reverse coater, so as to have a thickness of 3 μm after drying, and was dried at 100° C. for 2 minutes, and a binding layer was formed. Then, this film was cut to A5 size. The following processes were carried out in the same manner as for Sample 2-1 except that soda glass beads (trade name: MB-10; produced by Toshiba Barotini Co., Ltd.) having a volume average particle diameter of 4.1 μm, refractive index of 1.52, particle diameter distributions of 0.34, and roundness of 67%, were used as a filler, and a filler lens of Sample 2-6 for comparing was thereby formed. Since these fillers contained undefined particles, the longest diameter was measured as a diameter of each filler.

Sample 2-7

The same adhesive as that of Sample 2-1 was coated on one side of the same film as that of Sample 2-1 by a reverse coater, so as to have a thickness of 15 μm after drying, and was dried at 100° C. for 2 minutes, and a binding layer was formed. Then, this film was cut to A5 size. The following processes were carried out in the same manner as for Sample 2-1 except that methylmethacrylate beads (trade name: MR-20G; produced by Soken Chemical & Engineering Co., Ltd.) having a volume average particle diameter of 21.0 μm, refractive index of 1.50, particle diameter distributions of 0.29, and roundness of 94%, were used as a filler, and a filler lens of Sample 2-7 for comparing was thereby formed.

Sample 2-8

The same adhesive as that of Sample 2-1 was coated on one side of the same film as that of Sample 2-1 by a reverse coater, so as to have a thickness of 20 μm after drying, and was dried at 100° C. for 2 minutes, and a binding layer was formed. Then, this film was cut to A5 size. The following processes were carried out in the same manner as for Sample 2-1 except that soda glass beads (trade name: GB-731; produced by Toshiba Barotini Co., Ltd.) having a volume average particle diameter of 29.3 μm, refractive index of 1.52, particle diameter distributions of 0.23, and roundness of 94%, were used as a filler, and a filler lens of Sample 2-8 for comparing was thereby formed.

(2) Evaluation of Filler Lenses

\mathring{1} Observation of Filler Layer

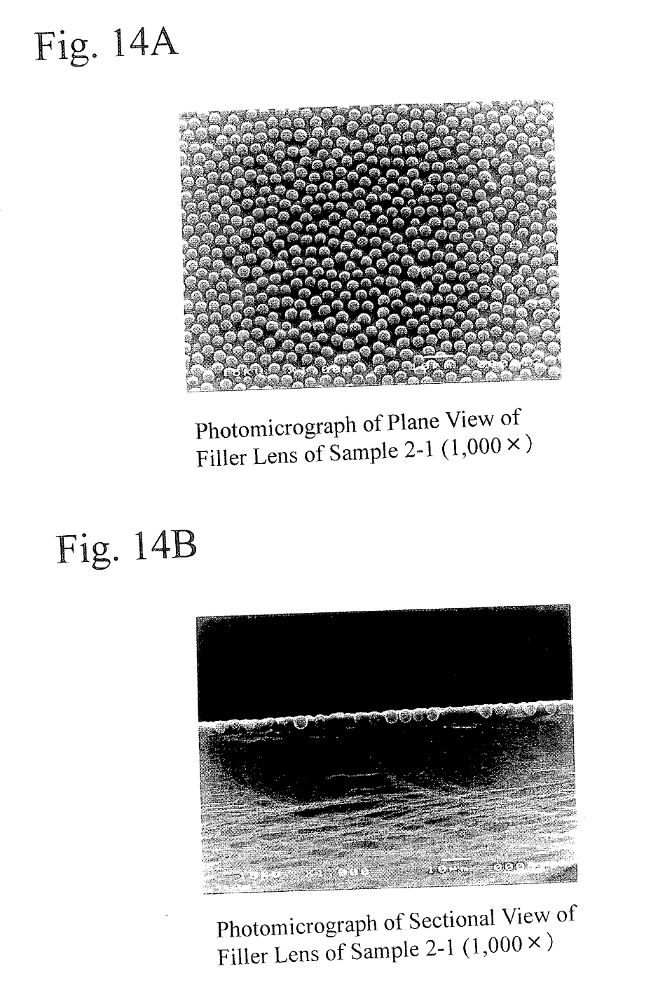

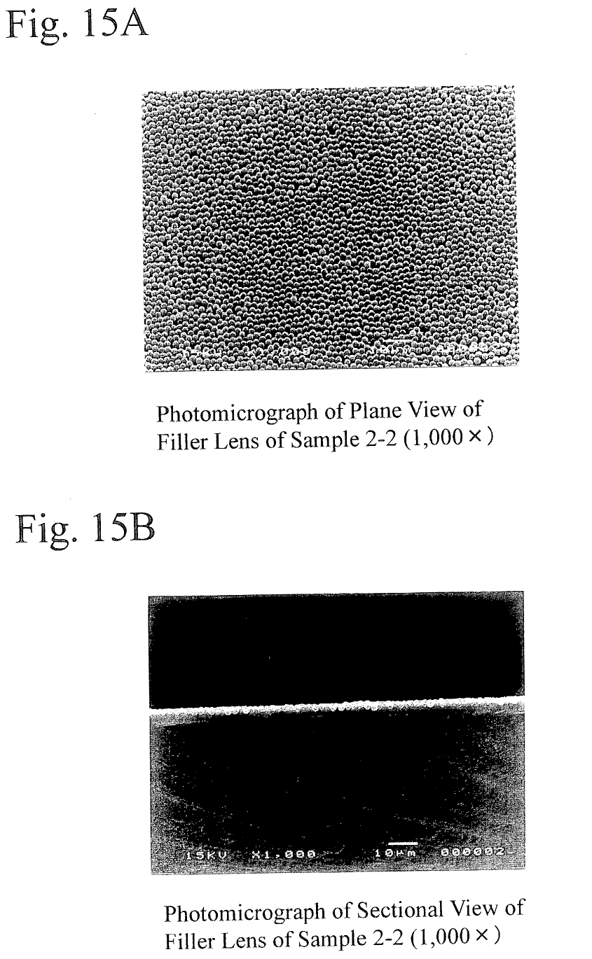

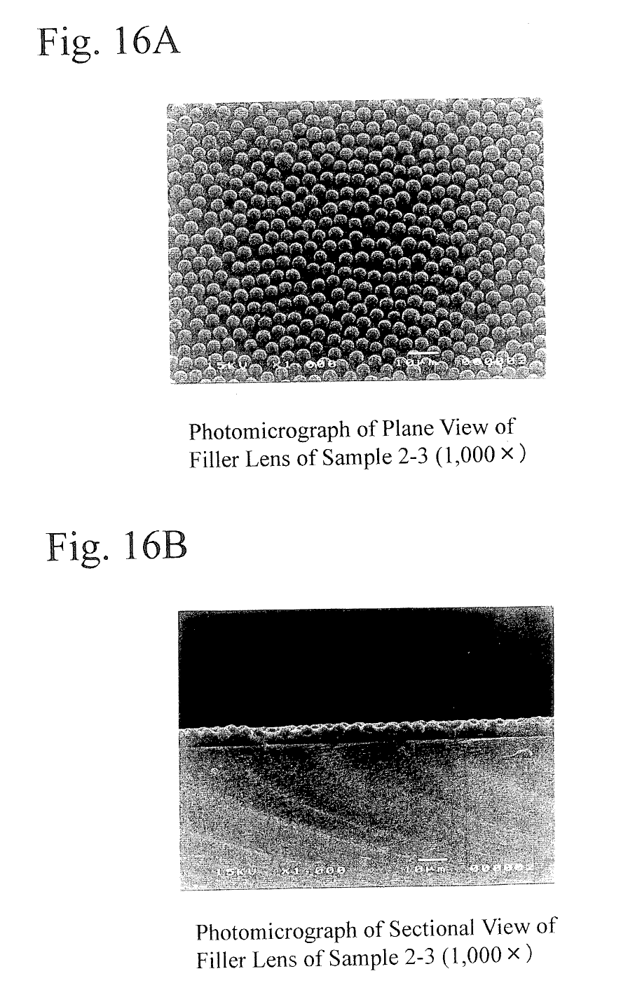

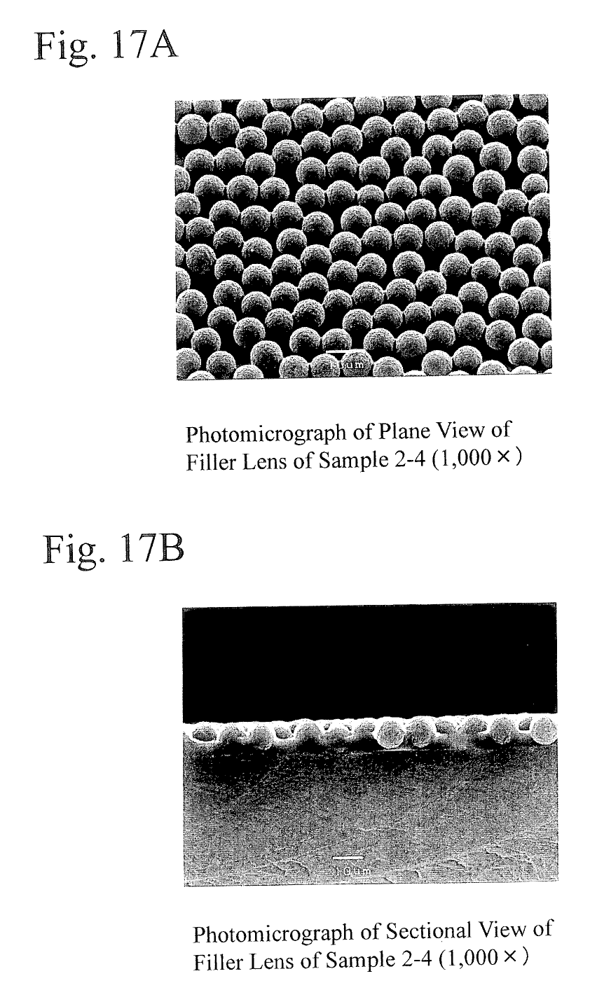

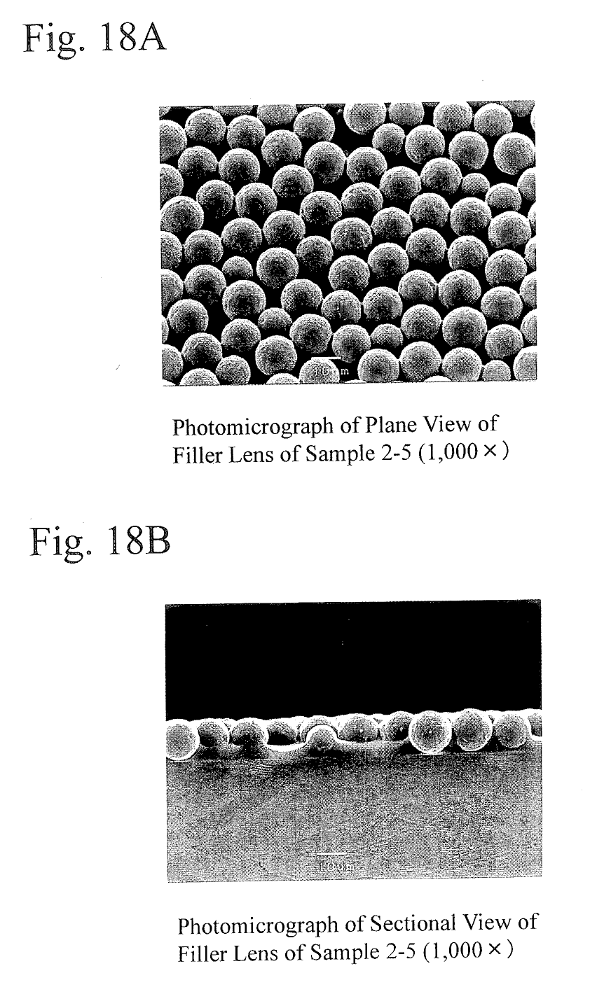

Plane views and sectional views of the filler layers in the filler lenses of Samples 2-1 to 2-8 were observed by an electron microscope. FIGS. 14 to 21 show electron photomicrographs of plane views and sectional views of filler lenses of Samples 2-1 to 2-8 at magnifications of 1,000×.

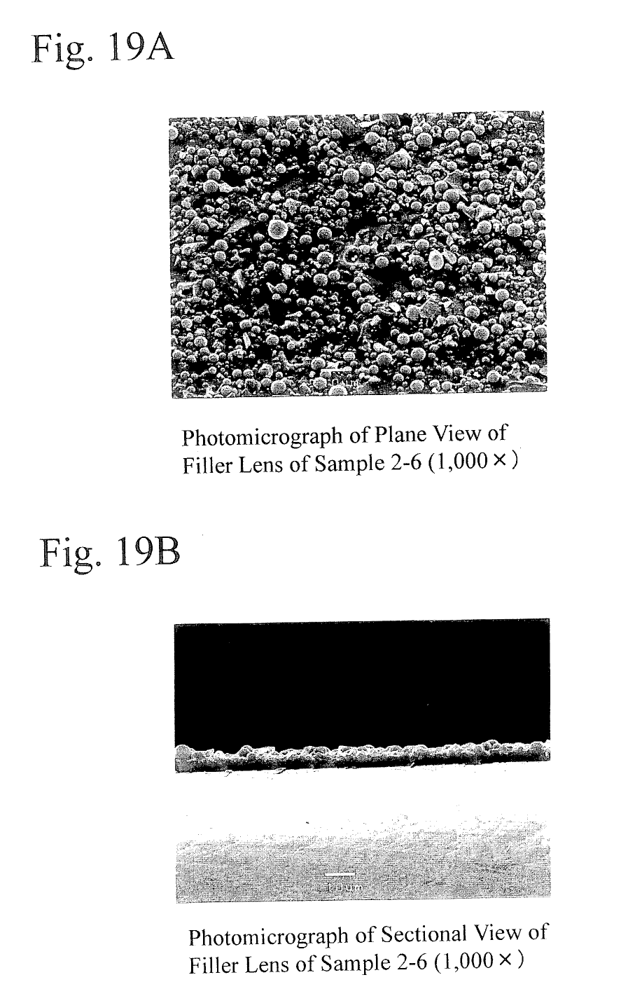

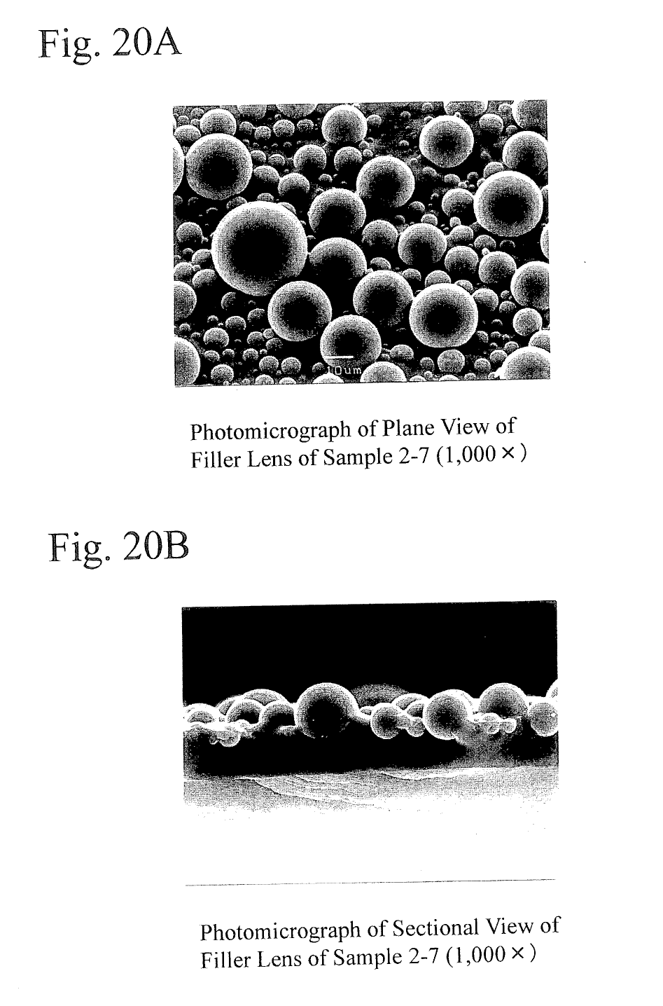

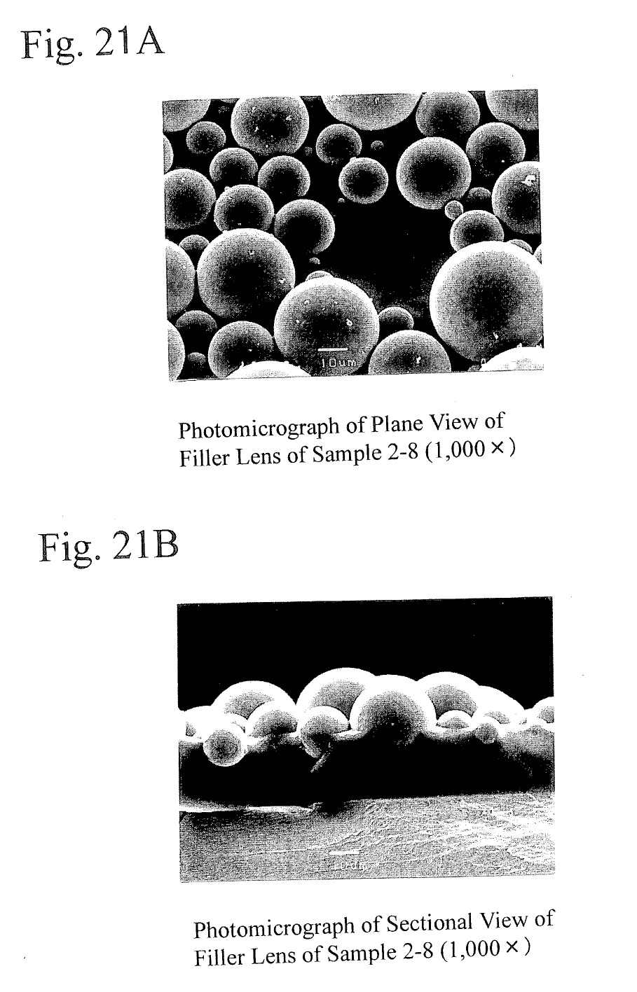

As is apparent from FIGS. 14 to 18, with respect to the filler lenses of Samples 2-1 to 2-5, the fillers are uniform in the planar direction at a high density, and in addition, depths thereof embedded to the binding layer are also uniform. In contrast, as is apparent from FIGS. 19 and 21, with respect to the filler lenses of Samples 2-6 and 2-8, a large number of fall out traces which seemed to be traces in which filler fell out in the process for washing surplus fillers, etc., were observed (central blank portions in FIGS. 19 and 21). Furthermore, with respect to Samples 2-7 and 2-8 in FIGS. 20 and 21, since volume average particle diameters of the fillers are large, it is apparent that areas of the fillers and the blank portions of the fillers are increased.

\mathring{2} Evaluation of Uniformity of Transmitted Light

The filler lenses of Samples 2-1 to 2-8 were observed by visual observation using transmitted light, and the uniformity of transmitted light was evaluated. In this evaluation, the following criteria were used: cases where the transmitted light was uniform on overall filler lens of A5 size: ◯; cases where light portions in which the light transparency was extremely high and dark portions in which the light transparency was extremely low since the fillers form a multilayer, are confirmed by visual observation, depending on places such fallen out portion of fillers, blank portions of fillers, etc.: ×. The evaluated results of the uniformity of transmitted light are given in Table 2.

\mathring{3} Evaluation of Fineness of Transmitted Light

The filler lenses of Samples 2-1 to 2-8 were observed by visual observation using transmitted light, and the fineness of the transmitted light was evaluated. In this evaluation, the following criteria were used: cases where the transmitted light was evenly observed: ◯; cases where the transmitted light was unevenly observed: ×. The evaluated results of the fineness of transmitted light are given in Table 2.

\mathring{7} Optical Property Test

With respect to the filler lenses of Samples 2-1 to 2-5, total light transmittance: Tt % and total light diffusivity: Hz % in the cases in which the light was transmitted from the filler side as shown in FIG. 12B, were measured using a spectrophotometer UV3100 produced by Shimadzu Corporation. The measured results are shown in Table 3.

As properties desired for the filler lens for display in practice, though a balance between luminance and visible angle is different depending on use of the display, it is preferable that Tt be 70% or more and that Hz be 60% or more.

TABLE 2

| | Uniformity of | Fineness of Transmitted |
|---|---|---|
| | Transmitted Light | Light |
| Sample 2-1 | ◯ | ◯ |
| Sample 2-2 | ◯ | ◯ |
| Sample 2-3 | ◯ | ◯ |
| Sample 2-4 | ◯ | ◯ |
| Sample 2-5 | ◯ | ◯ |
| Sample 2-6 | X | X |
| Sample 2-7 | ◯ | X |
| Sample 2-8 | X | X |

TABLE 3

| | Total Light Transmittance | Total Light Diffusivity |
|---|---|---|
| | Tt (%) | Hz (%) |
| Sample 2-1 | 96.89 | 80.42 |
| Sample 2-2 | 96.31 | 71.26 |
| Sample 2-3 | 97.12 | 82.28 |
| Sample 2-4 | 96.97 | 88.07 |
| Sample 2-5 | 95.78 | 89.27 |

As is apparent from Tables 2 and 3, with respect to optical properties, the filler lenses having a composition of the present invention exhibit adequate values in practice in both total light transmittance and total light diffusivity and have sufficient light diffusivity and transparency. Since fine organic fillers are used in the filler lenses, uniform and fine transmitted light is obtained. In addition, as is understood from Table 3, the diffusivity and transparency to light can be adjusted by changing the volume average particle diameter of the organic fillers.

In contrast, in the filler lenses of Samples 2-6 and 2-8 using inorganic fillers, the fillers fall out during washing since the adhesion of fillers to the binding layer is inferior, and therefore the transmitted light was extremely bright at portions at which the fillers fell out and was thereby nonuniform. Furthermore, in the filler lenses of Samples 2-7 and 2-8 using fillers in which the volume average particle diameters are larger than 15 μm, the transmitted light was uneven and was at such a level that it could not be used for display.

3. Third Embodiment

(1) Production of Filler Lens

Also in the third embodiment of the present invention, an acrylic polymer “a” used in the above second embodiment was employed in a binding layer as an adhesive.

Sample 3-1

As a transparent base material, a triacetyl cellulose film having a thickness of 80 μm (trade name: Fuji TAC UVD80; produced by Fuji Photo Film Co., Ltd.; refractive index 1.49; total light transmittance 92.4; Haze value 0.15) was used. An adhesive in which 0.45 parts by weight of isocyanate-type hardener (trade name: L-45; produced by Soken Chemical & Engineering Co., Ltd.) and 0.15 parts by weight of epoxy-type hardener (trade name: E-5XM; produced by Soken Chemical & Engineering Co., Ltd.) were added to 100 parts by weight of acrylic polymer “a”, was coated on one side of this TAC film by a reverse coater, so as to have a thickness of 5 μm after drying, and was dried at 100° C. for 2 minutes, and a binding layer was formed. Then, this film was cut to A5 size.

Next, methylsilicone beads (trade name: Tospearl 145; produced by GE Toshiba Silicone Co., Ltd.) having a volume average particle diameter of 4.5 μm, particle diameter distributions of 0.94, refractive index of 1.43, and roundness of 96%, were used as a filler, and were put into a porous plate container from which air was jetted from the bottom. Subsequently, this container was vibrated, and the fillers were flowed by synergistic effects of the vibration and the jetted air. The above film provided with a binding layer on the surface was passed therethrough for an appropriate period, and the fillers were thereby adhered on the surface of the binding layer.

Then, the fillers were embedded in the surface of the binding layer in the same manner as in the above first embodiment. Subsequently, the surplus fillers were washed away and removed by soaking the laminated film in 0.1% aqueous solution in which surfactant (trade name: Liponox NC-95; produced by Lion Corporation) was added to ion exchanged water and by using ultrasonic waves. Next, the film was pulled out of the solution and was sufficiently washed by ion exchanged water, and then the water was drained off the surface thereof by an air knife and was dried. Subsequently, the film was sufficiently dried by being left in a constant temperature oven at 40° C. for 7 days and was cooled at room temperature, and a filler lens of Sample 3-1 of the present invention was thereby formed.

Sample 3-2

The same adhesive as that of Sample 3-1 was coated on one side of the same transparent base film as that of Sample 3-1 by a reverse coater, so as to have a thickness of 5 μm after drying, and was dried at 100° C. for 2 minutes, and a binding layer was formed. Then, this film was cut to A5 size. The following processes were carried out in the same manner as for Sample 3-1 except that methylmethacrylate beads (trade name: MX-1000; produced by Soken Chemical & Engineering Co., Ltd.) having a volume average particle diameter of 10.8 μm, particle diameter distributions of 0.94, refractive index of 1.50, and roundness of 94%, were used as an organic filler, and a filler lens of Sample 3-2 of the present invention was thereby formed.

Sample 3-3

The same adhesive as that of Sample 3-1 was coated on one side of the same transparent base film as that of Sample 3-1 by a reverse coater, so as to have a thickness of 5 μm after drying, and was dried at 100° C. for 2 minutes, and a binding layer was formed. Then, this film was cut to A5 size. The following processes were carried out in the same manner as for Sample 3-1 except that methylmethacrylate beads (trade name: MX-1500H; produced by Soken Chemical & Engineering Co., Ltd.) having a volume average particle diameter of 14.9 μm, particle diameter distributions of 0.96, refractive index of 1.50, and roundness of 92%, were used as an organic filler, and a filler lens of Sample 3-3 of the present invention was thereby formed.

Sample 3-4

The same adhesive as that of Sample 3-1 was coated on one side of the same transparent base film as that of Sample 3-1 by a reverse coater, so as to have a thickness of 5 μm after drying, and was dried at 100° C. for 2 minutes, and a binding layer was formed. Then, this film was cut to A5 size. Next, the fillers used in Sample 3-1 were adhered on the binding layer in the same manner as for Sample 3-1. Then, the adhered filler layer was leveled on the surface so as to have a thickness of 12.5 μm, using a YBA-type baker applicator (produced by Yoshimitsu Seiki Co., Ltd). Subsequently, the film to which the fillers were adhered was inserted into a pressure roller (trade name: Lamipacker PD3204; produced by Fujipla Inc.) at a speed of 1.5 cm/second, and fillers were thereby embedded in the binding layer. The following processes were performed in the same manner as for Sample 3-1, and a filler lens of Sample 3-4 for comparing was thereby formed.

Sample 3-5

The same adhesive as that of Sample 3-1 was coated on one side of the same transparent base film as that of Sample 3-1 by a reverse coater, so as to have a thickness of 5 μm after drying, and was dried at 100° C. for 2 minutes, and a binding layer was formed. Then, this film was cut to A5 size. Next, the fillers used in Sample 3-1 were adhered on the binding layer in the same manner as for Sample 3-1, and the adhered filler layer was leveled on the surface so as to have a thickness of 12.5 μm, using a YBA-type baker applicator. When the film was inserted into the pressure roller in the next process, the pressure of the roller was increased by putting the base film to which the fillers adhered between two PET films having a thickness of 125 μm, and the fillers were thereby embedded in the binding layer. The following processes were carried out in the same manner as for Sample 3-1, and a filler lens of Sample 3-5 for comparing was thereby formed.

Sample 3-6

The same adhesive as that of Sample 3-1 was coated on one side of the same transparent base film as that of Sample 3-1 by a reverse coater, so as to have a thickness of 5 μm after drying, and was dried at 100° C. for 2 minutes, and a binding layer was formed. Then, this film was cut to A5 size. Next, the fillers used in Sample 3-2 were adhered on the binding layer in the same manner as for Sample 3-1, and the adhered filler layer was leveled on the surface so as to have a thickness of 25 μm by adjusting the gap of the YBA-type baker applicator. The following processes were carried out in the same manner as for Sample 3-4, and a filler lens of Sample 3-6 for comparing was thereby formed.

Sample 3-7

The same adhesive as that of Sample 3-1 was coated on one side of the same transparent base film as that of Sample 3-1 by a reverse coater, so as to have a thickness of 5 μm after drying, and was dried at 100° C. for 2 minutes, and a binding layer was formed. Then, this film was cut to A5 size. Next, the fillers used in Sample 3-3 were adhered on the binding layer in the same manner as for Sample 3-1, and the adhered filler layer was leveled on the surface so as to have a thickness of 25 μm by adjusting the gap of the YBA-type baker applicator. The following processes were carried out in the same manner as for Sample 3-4, and a filler lens of Sample 3-7 for comparing was thereby formed.

Sample 3-8

10 parts by weight of the fillers used in Sample 3-1 were added to 100 parts by weight of solid concentration of the adhesive used in Sample 3-1, and a coating solution was prepared by mixing for 1 hour using an azitaze. The prepared coating solution was coated on one side of the same transparent base film as that of Sample 3-1 by a comma coater, so as to have a thickness of 25 μm after drying, and was dried, and a filler layer was formed. A separation PET film (trade name: 3811; produced by Lintec Corporation) was laminated on a surface of this filler layer, and they were allowed to stand for 1 week in a constant temperature oven maintained at 40° C. and were cooled at room temperature. Subsequently, this film was cut to A5 size, then the separation PET film was peeled off, and a filler lens of Sample 3-8 for comparing was thereby formed.

(2) Evaluation of Filler Lens

\mathring{1} Observation of Filler Lens

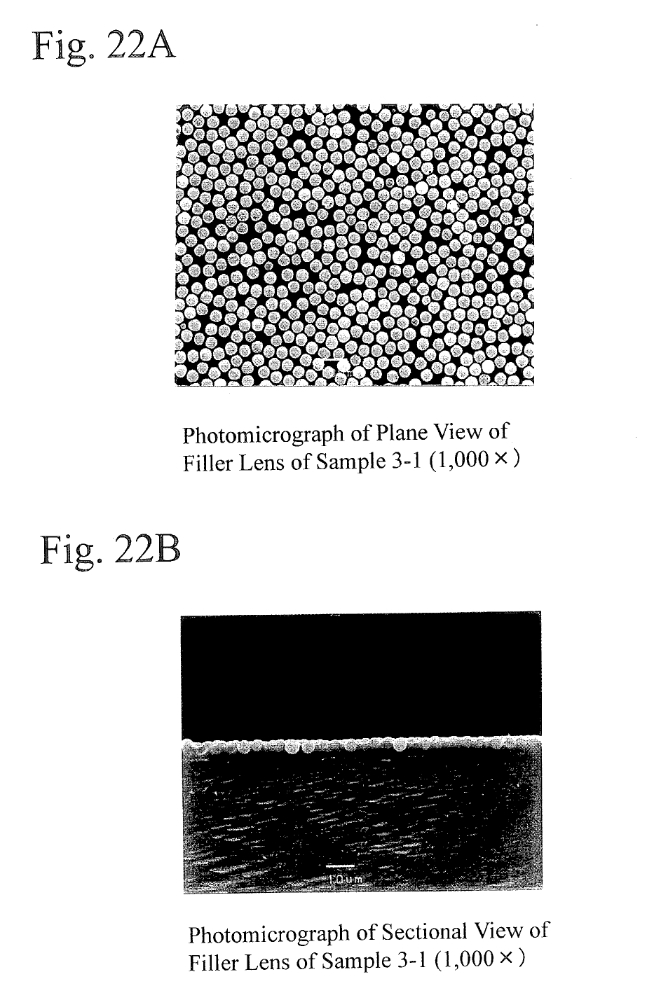

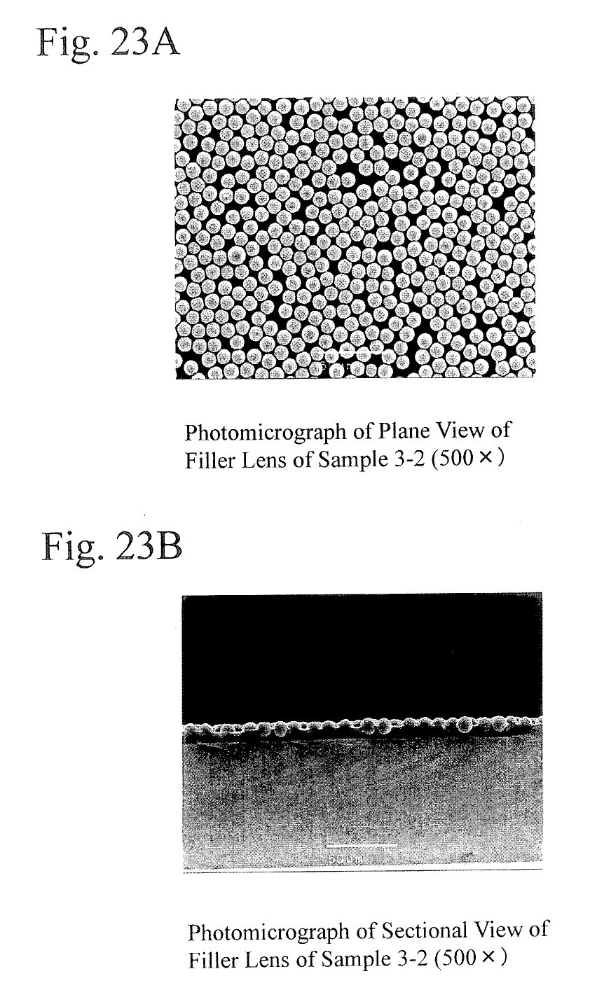

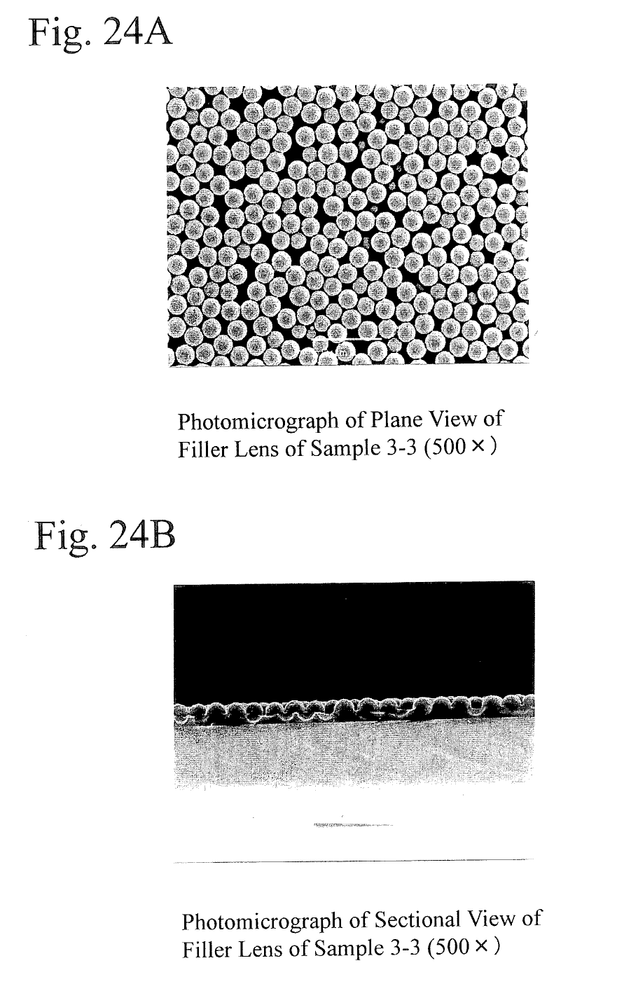

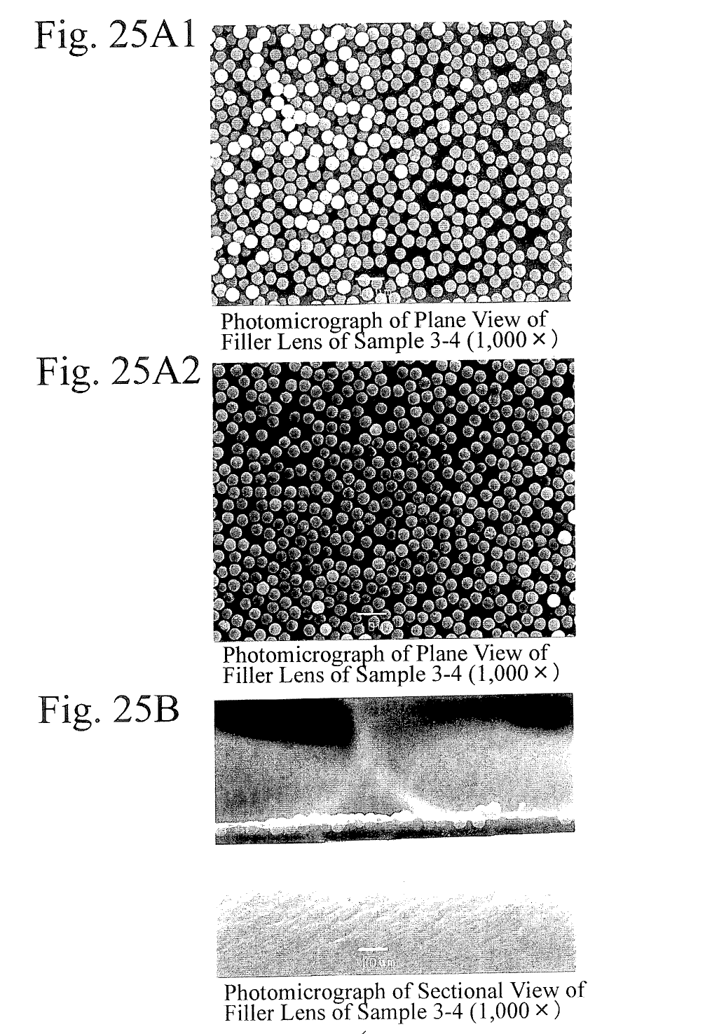

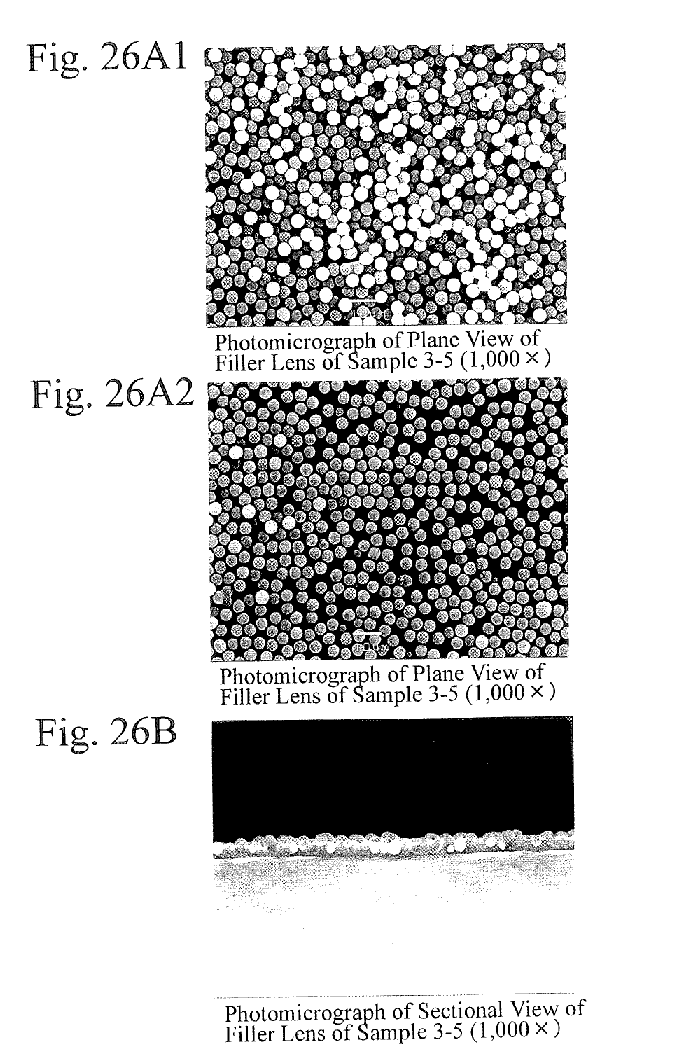

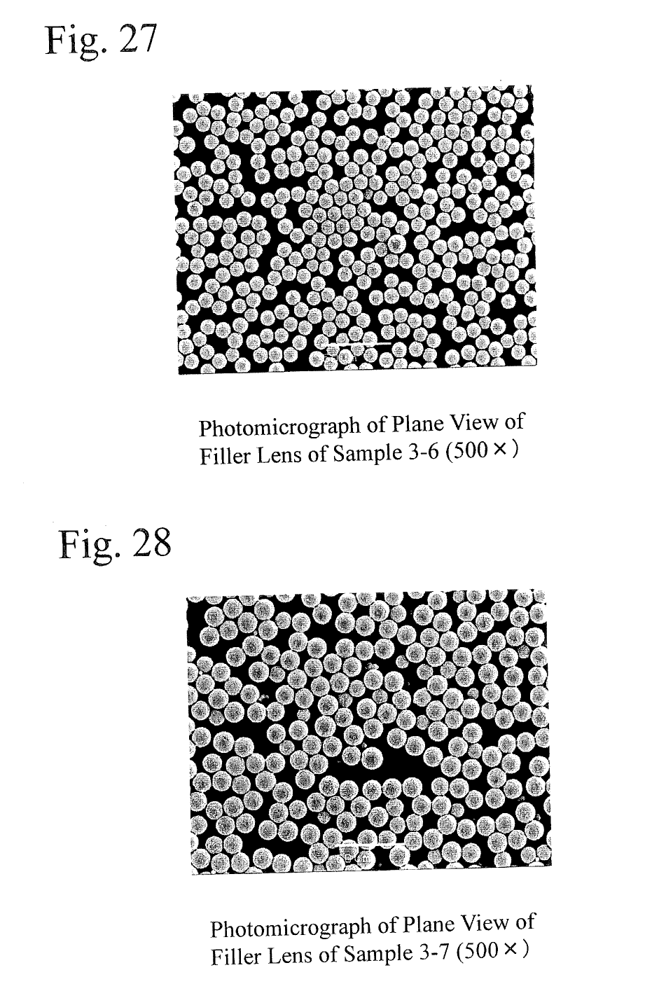

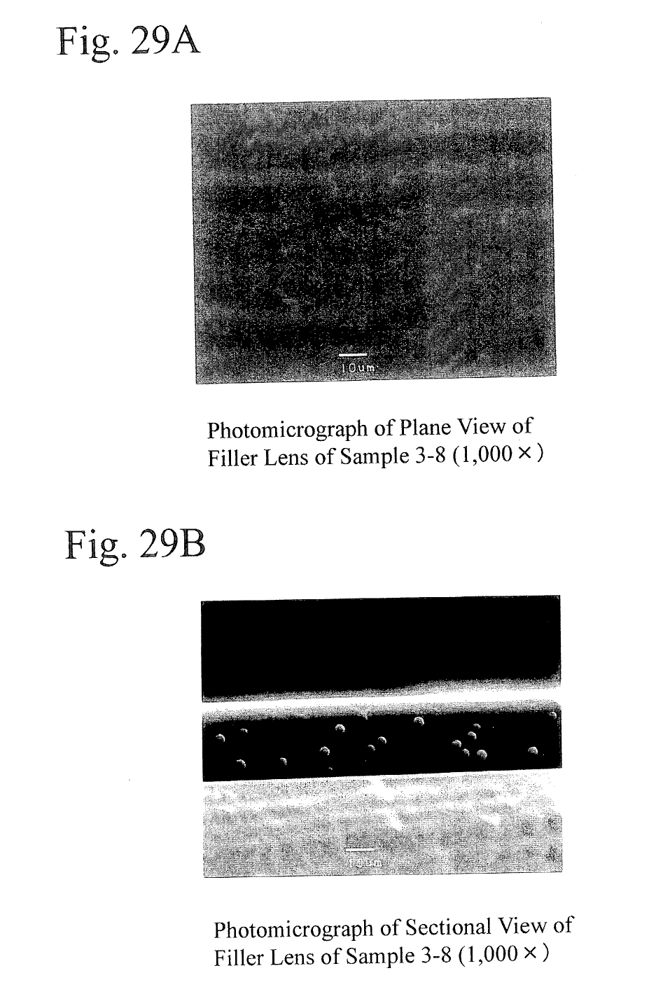

Plane views and sectional views of the filler lenses of Samples 3-1 to 3-8 which were obtained by the above methods were observed by an electron microscope. FIGS. 22A and 22B show electron photomicrographs of a plane view and a sectional view of a filler lens of Sample 3-1 at magnifications of 1,000×, respectively. FIGS. 23A and 23B show electron photomicrographs of a plane view and a sectional view of a filler lens of Sample 3-2 at magnifications of 500×, respectively. FIGS. 24A and 24B show electron photomicrographs of a plane view and a sectional view of a filler lens of Sample 3-3 at magnifications of 500×, respectively. FIGS. 25A and 25B show electron photomicrographs of a plane view and a sectional view of a filler lens of Sample 3-4 at magnifications of 1,000×, respectively. FIGS. 26A and 26B show electron photomicrographs of a plane view and a sectional view of a filler lens of Sample 3-5 at magnifications of 1,000×, respectively. FIGS. 27 and 28 show electron photomicrographs of plane views of filler lenses of Samples 3-6 and 3-7 at magnifications of 500×, respectively. FIGS. 29A and 29B show electron photomicrographs of a plane view and a sectional view of a filler lens of Sample 3-8 at magnifications of 1,000×, respectively.

As is apparent from the above plane photomicrographs shown in FIGS. 22A, 23A, and 24A, with respect to the filler lenses of Samples 3-1 to 3-3, the fillers are uniform in the planar direction at a high density and in addition, as is apparent from the sectional photomicrographs shown in FIGS. 22B, 23B, and 24B, with respect to the filler lenses of Samples 3-1 to 3-3, the filler layer is a monolayer and the fillers are embedded to uniform depth so that parts thereof protrude from the surface of the binding layer. In contrast, in the filler lenses of Samples 3-4 to 3-7 in which fillers were embedded in the binding layer by a roller, as shown in plane photomicrographs of FIGS. 25 to 28, the filling density of the fillers is nonuniform. In particular, in Samples 3-4 and 3-5, it appears that dense areas of fillers (FIGS. 25A1 and 26A1) and coarse areas thereof (FIGS. 25A2 and 26A2) are formed. In this dense areas of fillers, as is apparent from sectional views shown in FIGS. 25B and 26B, there were many portions having a composition such as a group in which other fillers adhere to a binding layer exposed from filler blanks in the first filler layer. As a reason for this, it was supposed that high pressure was exerted at this portion, fillers of the first filler layer are deeply embedded in the binding layer, and other fillers thereby adhere to adhesive pushed out from filler blanks.

Furthermore, in the conventional filler lens of Sample 3-8, as shown in FIG. 29A, the fillers were completely buried in the binding layer, and in addition, as shown in a sectional view of FIG. 29B, the fillers existed into the binding layer, as a multilayer.

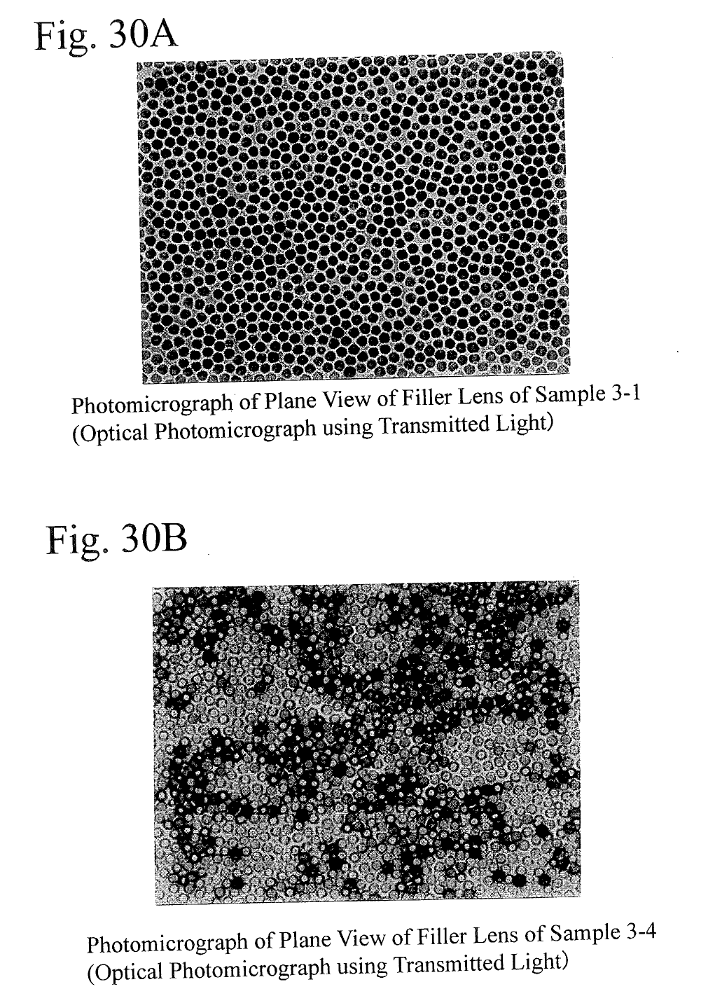

FIGS. 30A and 30B show optical photomicrographs of plane views of filler lenses of Samples 3-1 and 3-4, respectively, which are taken at a magnification of 50×using transmitted light. As is apparent from this optical photomicrograph, in Sample 3-1 in which the embedding depths of fillers are uniform, it was shown that the light transparency is uniform. In contrast, in Sample 3-4 in which the embedding depths of fillers are nonuniform and the fillers are partially piled up, it was shown that the light transparency is nonuniform.

\mathring{2} Measurement of Interparticle Distance of Filler

With respect to the filler lens of Samples 3-1 to 3-8, the distance between fillers in the planar direction was measured by a digital microscope (trade name: VH-6300; produced by Keyence Co., Ltd.). With respect to filler lenses using fillers having a volume average particle diameter of below 10 μm and filler lenses using fillers having a volume average particle diameter of 10 μm or more, interparticle distances of the fillers were measured at a magnification of 3000× or 1000×, respectively, using transmitted light, and standard deviations thereof were calculated.

\mathring{3} Optical Property Test

With respect to the filler lenses of Samples 3-1 to 3-8, total light transmittance: Tt % and total light diffusivity: Hz % in the cases in which the light was transmitted from the filler side as shown in FIG. 12B, were measured using a spectrophotometer UV3100 produced by Shimadzu Corporation.

\mathring{4} Evaluation of Uniformity of Transparency and Diffusivity of Light

The filler lenses of Samples 3-1 to 3-8 were observed by visual observation using transmitted light, and the uniformity of transmitted light was evaluated. The following criteria were used: cases where the transmitted light was uniform: ◯; cases where light portions in which the light transparency is extremely high and dark portions in which the light transparency is extremely low are confirmed, depending on locations: ×. The uniformity of transparency and diffusivity of light were evaluated.

The results are given in Table 4.

TABLE 4

| | | | Standard | Uniformity of |
|---|---|---|---|---|
| | Light Transmitting from | | Deviation of | Transmitted |
| | Filler Side | | Interparticle | Light (Visual |
| | Tt (%) | Hz (%) | Distance | Observation) |
| Sample 3-1 | 97.0 | 80.6 | 0.39 | ◯ |
| Sample 3-2 | 97.3 | 88.0 | 0.33 | ◯ |
| Sample 3-3 | 97.0 | 89.8 | 0.28 | ◯ |
| Sample 3-4 | 94.8 | 74.0 | 0.45 | X |
| Sample 3-5 | 95.0 | 75.5 | 0.44 | X |
| Sample 3-6 | 95.6 | 82.6 | 0.48 | X |
| Sample 3-7 | 95.1 | 83.1 | 0.47 | X |
| Sample 3-8 | 89.8 | 63.9 | Unmeasurable | ◯ |

As is apparent from Table 4, in the filler lenses of Samples 3-1 to 3-3, the standard deviations of interparticle distance of fillers were 0.4 or less. In contrast, the standard deviations of Samples 3-4 to 3-7 were larger than 0.4. In addition, the filler lens of Sample 3-8 could not be brought into focus by an optical microscope using transmitted light since the fillers were completely buried in the binding layer, and the interparticle distance of fillers therefore could not be measured.

Furthermore, although the total light dispersivities of the filler lenses of Samples 3-1 to 3-7 having a structure shown in FIG. 1 are higher than that of the conventional filler lens of Sample 3-8 in which the filler layer is a multilayer as shown in FIG. 2, the total light transmittances thereof are also high. Therefore, the filler lenses of Samples 3-1 to 3-7 are superior in light transmittance and light diffusivity.

4. Fourth Embodiment

(1) Production of Filler Lens

Also in the fourth embodiment of the present invention, an acrylic polymer “a” used in the above second embodiment was employed in a binding layer, as an adhesive.

Sample 4-1

As a transparent base material, a triacetyl cellulose film having a thickness of 80 μm (trade name: Fuji TAC UVD80; produced by Fuji Photo Film Co., Ltd.; refractive index of 1.49) was used. An adhesive in which 0.4 parts by weight of isocyanate-type hardener (trade name: L-45; produced by Soken Chemical & Engineering Co., Ltd.) and 0.2 parts by weight of epoxy-type hardener (trade name: E-5XM; produced by Soken Chemical & Engineering Co., Ltd.) were added to 100 parts by weight of acrylic polymer “a”, was coated on one side of this TAC film by a reverse coater, so as to have a thickness of 5 μm after drying, and was dried at 100° C. for 2 minutes. Then, a separation PET film (trade name: 3811; produced by Lintec Corporation) was laminated thereon, and they were allowed to stand for 1 week in a constant temperature oven maintained at 40° C. and the binding layer was cured. Subsequently, this film was cut to A5 size, then the separation PET film was peeled off.

Next, methylsilicone beads (trade name: Tospearl 145; produced by GE Toshiba Silicone Co., Ltd.) having a volume average particle diameter of 4.5 μm, particle diameter distributions of 0.94, refractive index of 1.43, and roundness of 96%, were used as a filler, and were put into a porous plate container from which air was jetted from the bottom. Subsequently, this container was vibrated, and the fillers were flowed by synergistic effects of the vibration and the jetted air. The above film provided with a binding layer on the surface was passed therethrough for an appropriate period, and the fillers were thereby adhered on the surface of the binding layer.

Then, the fillers were embedded in the surface of the binding layer in the same manner as in the above first embodiment, and a filler layer was formed. Subsequently, the surplus fillers were washed away and were removed by soaking the laminated film in 0.1% aqueous solution in which surfactant (trade name: Liponox NC-95; produced by Lion Corporation) was added to ion exchanged water and by using ultrasonic waves. Next, the film was pulled out of the solution and was sufficiently washed by ion exchanged water, and then the water was drained off the surface thereof by an air knife and was dried. Subsequently, the film was sufficiently dried by being left in a constant temperature oven at 40° C. for 5 days and was cooled at room temperature, and a filler lens of Sample 4-1 of the present invention was thereby formed. Gel percentage of the binding layer in this filler lens was 64%.

Sample 4-2

An adhesive in which 1.0 parts by weight of isocyanate-type hardener (trade name: L-45; produced by Soken Chemical & Engineering Co., Ltd.) and 0.5 parts by weight of epoxy-type hardener (trade name: E-5XM; produced by Soken Chemical & Engineering Co., Ltd.) were added to 100 parts by weight of acrylic polymer “a”, was coated on one side of the same transparent base film as that of Sample 4-1 by a reverse coater, so as to have a thickness of 5 μm after drying, and was dried at 100%C for 2 minutes. Then, a separation PET film (trade name: 3811; produced by Lintec Corporation) was laminated thereon, and they were allowed to stand for 7 days in a constant temperature oven maintained at 40° C. and the binding layer was cured. Subsequently, this film was cut to A5 size, and then the separation PET film was peeled off. The following processes were carried out in the same manner as for Sample 4-1 and a filler lens of Sample 4-2 of the present invention was thereby formed. Gel percentage of the binding layer in this filler lens was 90%.

Sample 4-3

The same manner of processing as for Sample 4-1 was carried out, except that hardener was not used in the coating solution of the binding layer at all, and a filler lens of Sample 4-3 for comparing was formed. Gel percentage of the binding layer in this filler lens was 1%.

Sample 4-4

The same manner of processing as for Sample 4-1 was carried out, except that an adhesive in which 0.2 parts by weight of isocyanate-type hardener (trade name: L-45; produced by Soken Chemical & Engineering Co., Ltd.) and 0.1 parts by weight of epoxy-type hardener (trade name: E-5XM; produced by Soken Chemical & Engineering Co., Ltd.) were added to 100 parts by weight of acrylic polymer “a” was used, and a filler lens of Sample 4-4 for comparing was formed. Gel percentage of the binding layer in this filler lens was 42%.

(2) Evaluation of Filler Lens

\mathring{2} Observation of Filler Layer and Measurement of Protruding Ratio of Filler

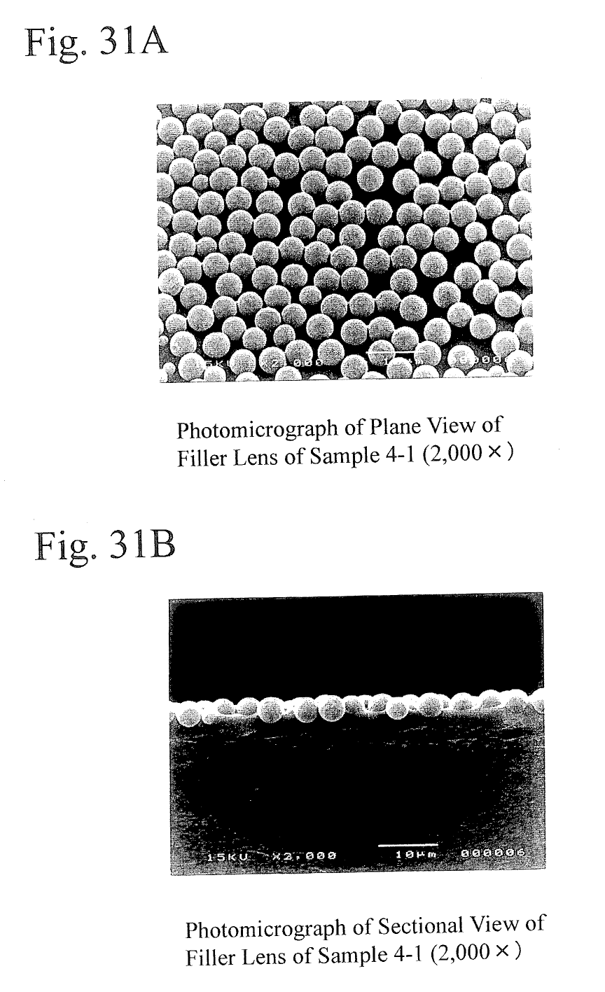

Plane views and sectional views of the filler lenses of Samples 4-1 to 4-4 were observed by an electron microscope. FIGS. 31 to 34 show electron photomicrographs of a plane view and a sectional view of the filler lenses of Samples 4-1 to 4-4 at a magnification of 2,000×, respectively.

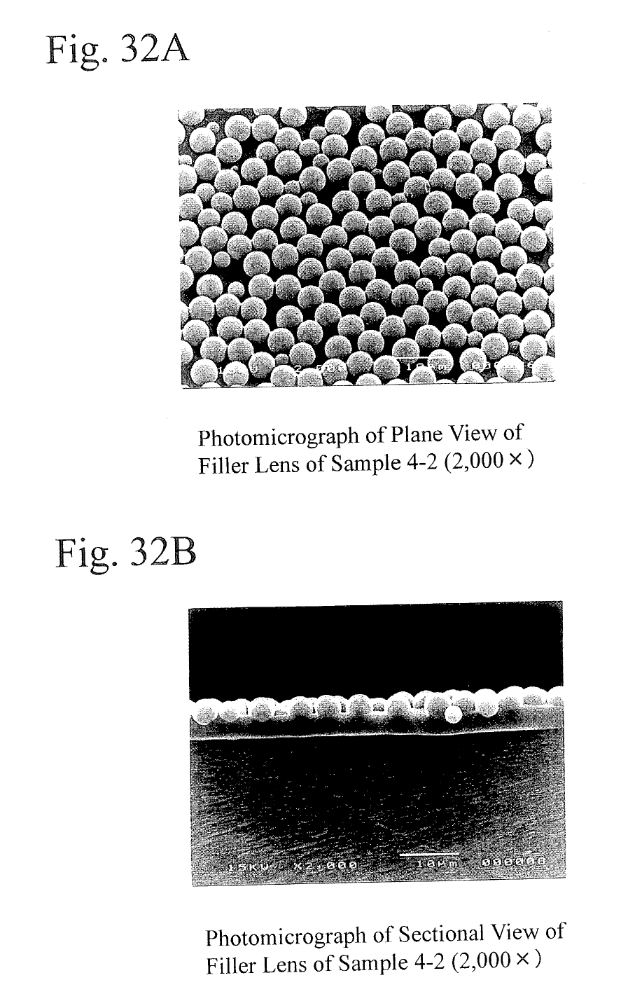

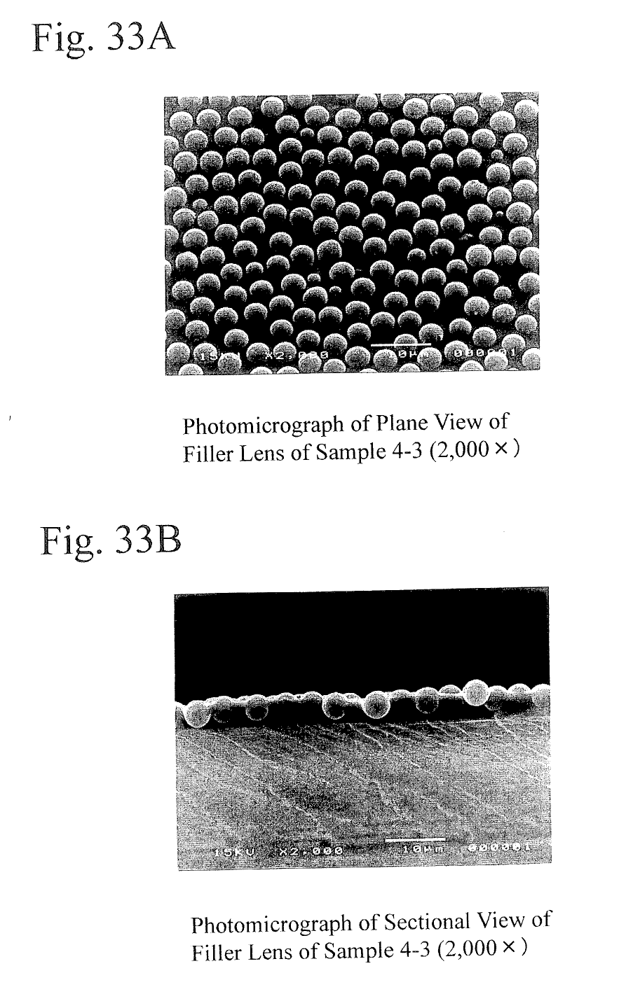

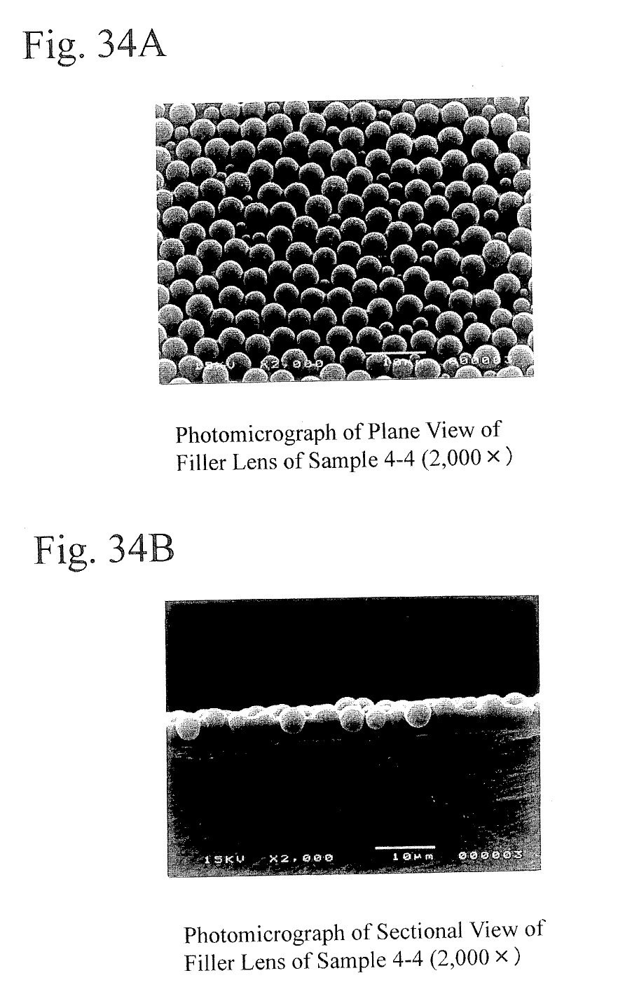

As is apparent from FIG. 31, in the filler lens of Sample 4-1, fillers protruded from the binding layer so that protruding ratio of filler was 55%, and a filler layer was formed as a uniform monolayer. As is apparent from FIG. 32, in the filler lens of Sample 4-2, fillers protruded from the binding layer so that the protruding ratio of filler was 66%, and a filler layer was formed as a uniform monolayer. In contrast, as is apparent from FIG. 33, in the filler lens of Sample 4-3, fillers protruded from the binding layer so that the protruding ratio of filler is 24%, and a filler layer was formed as a uniform monolayer. As is apparent from FIG. 34, in the filler lens of Sample 4-4, fillers protruded from the binding layer so that the protruding ratio of filler was 39%, and a filler layer was formed as a uniform monolayer.

\mathring{2} Optical Property Test

With respect to the above filler lenses of Samples 4-1 to 4-4, total light diffusivity: Hz % in the cases in which the light was transmitted from the filler 3 side as shown in FIG. 12B and the cases in which the light was transmitted from the film 1 side as shown in FIG. 12A, were measured using a spectrophotometer UV3100 produced by Shimadzu Corporation. The measured results are given in Table 5.

\mathring{3} Reliability Test

The above filler lenses of Samples 4-1 to 4-4 were allowed to stand for 500 hours in a high temperature and high humidity oven maintained at 60° C. and 90% RH, and were allowed to stand for 24 hours at room temperature. Haze values (total light diffusivity): Hz % in the cases in which the light was transmitted from the filler 3 side, as shown in FIG. 12B, and the cases in which the light was transmitted from the film 1 side, as shown in FIG. 12A, were measured using a spectrophotometer UV3100 produced by Shimadzu Corporation. The measured results are given in Table 5.

\mathring{4} Confirmation of Paper Whiteness and Uniformity

The above filler lenses of Samples 4-1 to 4-4 were put on a flat plate having aluminum deposited on the surface thereof, so that the filler side faced upward, and paper whiteness was confirmed by visual observation. In this confirmation, the following criteria were used: cases where the background was close to the paper-white color: ◯, and cases where the ground color of aluminum was observed: ×. At this time, the uniformity of the paper-white color was also evaluated by visual observation: cases where the color was uniform: ◯, and cases where the color was partially nonuniform: ×. The evaluated results of the paper whiteness and the uniformity are given in Table 5.

TABLE 5

| | | | Light Transmitting from | | Light Transmitting from | | Paper | |
|---|---|---|---|---|---|---|---|---|
| | Gel | Protruding | Filler Side (%) | | Film Side (%) | | Whiteness | Uniformity |
| | percentage | Ratio of | | After Reliability | | After Reliablility | (Visual | (Visual |
| | (%) | Filler (%) | Start | Test of 500 hours | Start | Test of 500 hours | Observation) | Observation) |
| Sample 4-1 | 64 | 55 | 88.65 | 86.39 | 87.21 | 84.99 | ◯ | ◯ |
| Sample 4-2 | 90 | 66 | 89.54 | 89.31 | 88.67 | 88.53 | ◯ | ◯ |
| Sample 4-3 | 1 | 24 | 76.88 | 60.11 | 75.35 | 59.84 | X | ◯ |
| Sample 4-4 | 42 | 39 | 80.32 | 69.79 | 78.98 | 68.22 | X | ◯ |

In the filler lenses of Samples 4-1 and 4-2, according to Table 5, start Haze values were about 87 to 90% even if the light was transmitted from the filler side or from the film side, and the light diffusivities thereof were sufficient in practice, and in addition, the paper whitenesses were also superior. In contrast, in the filler lenses of Samples 4-3 and 4-4, start Haze values were about 75 to 81%, and the paper whitenesses were insufficient. Furthermore, with respect to the reliability test, in the filler lenses of Sample 4-1 and 4-2, there were seldom changes in the Haze values, and the reliabilities thereof were superior. In contrast, in the filler lenses of Sample 4-3 and 4-4, the Haze values were decreased 10 to 15% and it was difficult to use them for displays, etc.

5. Fifth Embodiment

(1) Production of Filler Lens

In the fifth embodiment of the present invention, ethyl acetate was added to the acrylic polymer solution polymerize in the above second embodiment, so that the solid concentration was 20% by weight, and acrylic polymer “b” was prepared and was used in a binding layer of the following filler lenses.

Sample 5-1

As a transparent base material, a triacetyl cellulose film having a thickness of 80 μm (trade name: Fuji TAC UVD80; produced by Fuji Photo Film Co., Ltd.; refractive index 1.49) was used. An adhesive in which 0.5 parts by weight of isocyanate-type hardener (trade name: L-45; produced by Soken Chemical & Engineering Co., Ltd.) and 0.2 parts by weight of epoxy-type hardener (trade name: E-5XM; produced by Soken Chemical & Engineering Co., Ltd.) were added to 100 parts by weight of acrylic polymer “b”, was coated on one side of this TAC film by a reverse coater, so as to have a thickness of 5 μm after drying, and was dried at 100° C. for 2 minutes, and a binding layer was formed. Then, this film was cut to A5 size.

Next, methylsilicone fillers (trade name: Tospearl 145; produced by GE Toshiba Silicone Co., Ltd.) having a volume average particle diameter of 4.5 μm, particle diameter distributions of 0.94, refractive index of 1.43, and roundness of 96%, used as a filler, were put into a porous plate container from which air was jetted from the bottom. Subsequently, this container was vibrated, and the fillers were flowed by synergistic effects of the vibration and the jetted air. The above film provided with a binding layer on the surface was passed therethrough for an appropriate period, and the fillers were thereby adhered on the surface of the binding layer.

Then, the fillers were embedded in the surface of the binding layer in the same manner as in the above first embodiment, and a filler layer was formed. Subsequently, the filler layer was washed by a hydraulic shower of an aqueous solution in which 0.1 parts by weight of surfactant (trade name: Liponox NC-95; produced by Lion Corporation) was added to 100 parts by weight of ion exchanged water, and the surplus fillers were thereby removed. Next, the film was sufficiently washed by ion exchanged water, and then the entire film was dried by blowing air.

Subsequently, the above film having a filler layer embedded in the surface of the binding layer was left in a constant temperature oven at 60° C. for 2 days, the binding layer was softened, the fillers were fitted in with the binding layer, and elevated portions of the binding layer were thereby formed around the fillers. Then, the film was pulled out from the constant temperature oven and was allowed to cool, and a filler lens of Sample 5-1 of the present invention was thereby formed.

Sample 5-2

The same adhesive as that of Sample 5-1 was coated on one side of the same transparent base film as that of Sample 5-1 by a reverse coater, so as to have a thickness of 5 μm after drying, and was dried at 100° C. for 2 minutes. Then, a separation PET film (trade name: 3811; produced by Lintec Corporation) was laminated thereon, and they were allowed to stand for 1 week in a constant temperature oven maintained at 40° C., then the separation PET film was peeled off, and the binding layer was thereby formed. Subsequently, this film was cut to A5 size.

Next, the processes of Sample 5-1 for adhering fillers and for embedding fillers in the binding layer by pressure media were carried out, using the filler of Sample 5-1. Then, the laminated film was put into the same washing solution as for Sample 5-1, the surplus fillers were removed by ultrasonic waves, the film was sufficiently rinsed using the ion exchanged water, and the entire film was dried by blowing air.

Subsequently, the above film having a filler layer embedded in the surface of the binding layer was left in a high temperature and high humidity oven at 40° C. and 90% RH for 3 days, and the binding layer was softened. Then, the film was pulled out from the high temperature and high humidity oven and was allowed to cool, and a filler lens of Sample 5-2 of the present invention was thereby formed.

Sample 5-3

The same manner of processing as for Sample 5-2 was carried out, except that the process for softening a binding layer was omitted, and a filler lens of Sample 5-3 for comparing was formed.

(2) Evaluation of Filler Lens

\mathring{1} Observation of Filler Layer

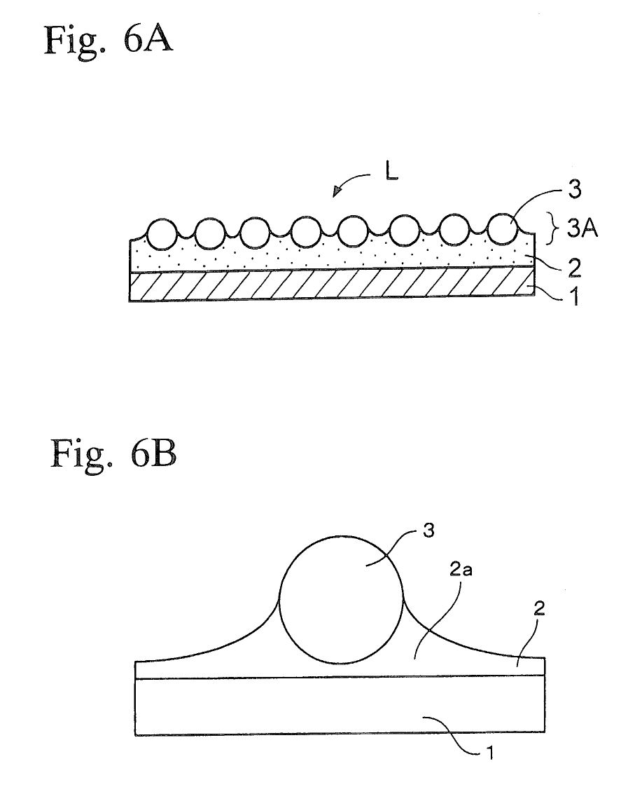

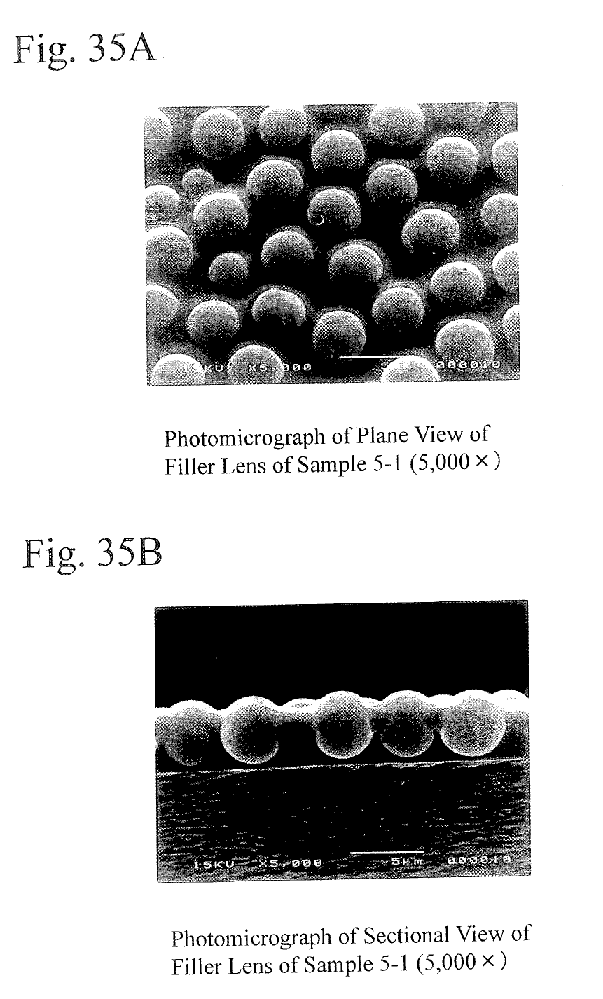

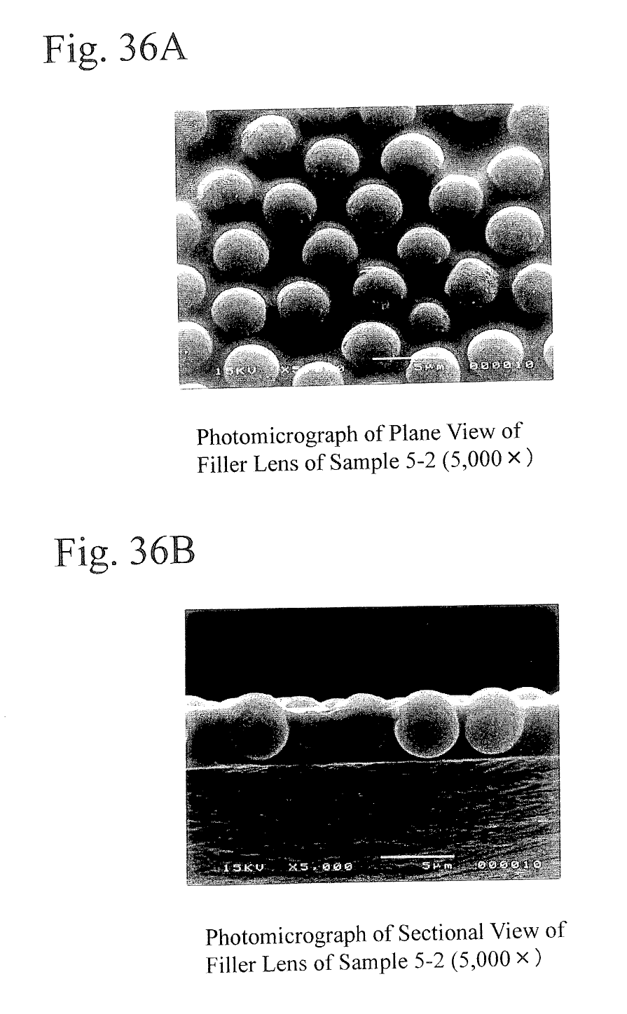

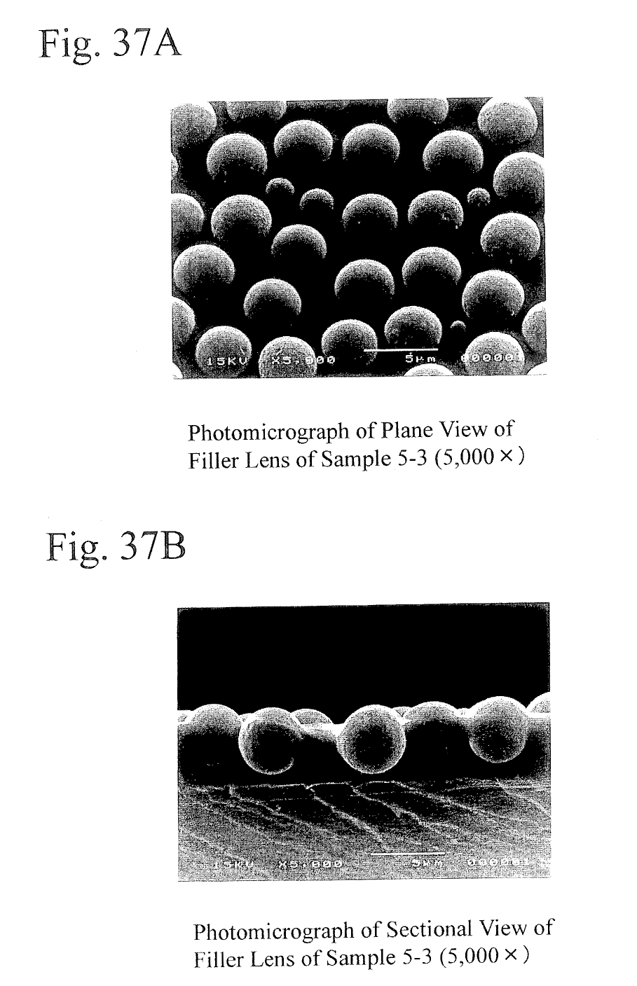

Plane views and sectional views of the filler lenses of Samples 5-1 to 5-3 were observed by an electron microscope. FIGS. 35 to 37 show electron photomicrographs of a plane view and a sectional view of the filler lenses of Samples 5-1 to 5-3 at a magnification of 5,000×, respectively. As is apparent from FIGS. 35 and 36, the filler lenses of Samples 5-1 and 5-2 had elevated portions of the binding layer around the fillers, fillers protruded from the binding layer, and a filler layer was formed as a uniform monolayer. The filler lenses had a composition shown in FIG. 6. In contrast, as is apparent from FIG. 37, the filler lens of Sample 5-3 had a composition in which no elevated portion of the binding layer was formed around the fillers.

\mathring{2} Optical Property Test

With respect to the above filler lenses of Samples 5-1 to 5-3, total light transmittance: Tt % and Haze value (total light diffusivity): Hz % in the cases in which light was transmitted from the film 1 side, as shown in FIG. 12A, and light was transmitted from the filler 3 side, as shown in FIG. 12B, were measured using a spectrophotometer UV3100 produced by Shimadzu Corporation. The measured results are shown in Table 6.

TABLE 6

| | Light Transmitting from | | Light Transmitting from | |
|---|---|---|---|---|
| | Film Side | | Filler Side | |
| | Tt % | Hz % | Tt % | Hz % |
| Sample 5-1 | 92.12 | 78.42 | 96.68 | 79.69 |
| Sample 5-2 | 91.55 | 80.56 | 96.91 | 81.40 |
| Sample 5-3 | 75.18 | 80.62 | 96.83 | 80.95 |

According to Table 6, in the filler lenses of Samples 5-1 and 5-2, total light transmittances in the case in which the light was transmitted from the film side were about 91 to 92%. In contrast, in the filler lens of Sample 5-3, it was about 75%. That is, it was confirmed that the light transparencies to the light transmitted from the film side of the filler lenses of Samples 5-1 and 5-2, are 16 to 17% higher than that of the filler lens of Sample 5-3. In addition, the filler lenses of Samples 5-1 to 5-3 had Haze values of about 78 to 81% and sufficient light diffusivities. In contrast, with respect to the light transmitted from the filler side, the filler lens of Samples 5-1 to 5-3 had a total light transmittance of about 96 to 97% and extremely high light transparency. In addition, it had a Haze value of about 79 to 81% and sufficient light diffusivities.

That is, in the filler lenses of Samples 5-1 and 5-2, the light diffusivities and the light transparencies to the light transmitted from the filler side were equivalent to those of conventional products. The light diffusivities to the light transmitted from the film side were sufficient, and the light transparencies were about 16 to 17% better than that of the conventional products. Since total light transmittance of the TAC film itself is about 92% and the Haze value is about 0.2%, it was confirmed that the filler lenses of the present invention have sufficient light diffusivities to the light transmitted from both directions and seldom have loss of light transparencies.

6. Sixth Embodiment

(1) Production of Filler Lens

Firstly, a blocked isocyanate hardener employed in a binding layer of the sixth embodiment according to the present invention, is explained.

The composition below was added to a four-neck flask having a reflux condenser, a thermometer, and a stirrer, and a polyurethane reaction was carried out until the isocyanate content reached a desired value. Then, 4 parts by weight of ethyleneglycol mono-n-hexylether was added thereto, blocking reaction of the isocyanate groups was carried out, and a blocked isocyanate hardener was thereby prepared and was employed in the following coating solutions for the binding layer for the filler lens.

Composition of Blocked Isocyanate Hardener

Polydiphenylmethane diisocyanate (trade name: Milionate MR 120; produced by Nippon Polyurethane Industry Co., Ltd.), 45 parts by weight

2-hydroxy ethylacrylate, 31 parts by weight

Butyl acetate, 20 parts by weight

Sample 6-1

As a transparent base material, a triacetyl cellulose film having a thickness of 80 μm (trade name: Fuji TAC UVD80; produced by Fuji Photo Film Co., Ltd.; refractive index 1.49) was used. A coating solution for the binding layer having the composition below was mixed for 15 minutes by a disper, was coated on one side of this TAC film by a reverse coater, so as to have a thickness of 10 μm after drying, and was dried at 100° C. for 2 minutes. Subsequently, aging was carried out at 30° C. for 1 week, and a binding layer was thereby formed.

Composition of Coating Solution for Binding Layer

Acrylic-type adhesive (trade name: SK Dain 1852; produced by Soken Chemical & Engineering Co., Ltd.; total solid concentration in ethylacetate of 23%), 100 parts by weight

Acrylic-type compound

Tripentaerythritol polyacrylate, 45 parts by weight

The above blocked isocyanate hardener, 1.5 parts by weight

Isopropyl alcohol, 5 parts by weight

Methylethylketone, 210 parts by weight

Ethylacetate, 650 parts by weight

Next, methyl silicone fillers, having a monodispersive particle diameter of 4.5 μm and refractive index of 1.45, were employed as a filler, and were put into a porous plate container from which air was jetted from the bottom. Subsequently, this container was vibrated, and the fillers were flowed by synergistic effects of the vibration and the jetted air. The above film provided with a binding layer on the surface was passed therethrough for an appropriate period, and the fillers were thereby adhered on the surface of the binding layer.

Then, the fillers were embedded in the surface of the binding layer in the same manner as in the above first embodiment, a filler layer was formed, and then the coated layer of the above film was cured by heating at 120° C. for 5 minutes. Subsequently, the filler layer was washed by a hydraulic shower of ion exchanged water, and the surplus fillers were thereby removed. Next, the entire film was dried by blowing air, and a filler lens of Sample 6-1 of the present invention was thereby formed.

Sample 6-2

The same manner of processing as for Sample 6-1 was carried out, except that dipentaerythritol triacrylate was employed as an acrylic-type compound in the coating solution for the binding layer, instead of tripentaerythritol polyacrylate, and a filler lens of Sample 6-2 of the present invention was formed.

Sample 6-3

A coating solution, obtained by dispersing a mixture consisting of the composition below for 30 minutes using a sand mill, was coated on one surface of triacetyl cellulose (trade name: Fuji Tac UVD80; produced by Fuji Photo Film Co., Ltd.) which is a transparent base material having a film thickness of 80 μm, and a transmittance of 92%, by a reverse coating method, and this was then dried for 2 minutes at 100° C. Subsequently, the film was exposed to UV radiation to cure the coating film, under the conditions of output power: 120 W/cm; source distance: 10 cm; and exposure time: 30 seconds; using one converging type high-pressure mercury lamp. Thus, a filler lens of Sample 6-3 for comparing was formed.

Composition of Coating Solution

Epoxy acrylic-type UV curable resin (trade name: KR-566; produced by Asahi Denka Kogyo K. K.; total solid concentration of 95%), 95 parts by weight

Closslinked acrylic bead pigment (trade name: MX150; produced by Soken Chemical & Engineering Co., Ltd.; particle diameter of 1.5 μm±0.5), 10 parts by weight

Isopropyl alcohol, 230 parts by weight

Sample 6-4

The same manner of processing as for Sample 6-1 was carried out, except that the composition of the coating solution for binding layer in Sample 6-1 was changed to the composition below, and a filler lens of Sample 6-4 for comparing was formed.

Composition of Coating Solution for Binding layer

Acrylic-type adhesive (trade name: SK Dain 811L; produced by Soken Chemical & Engineering Co., Ltd.; total solid concentration in ethylacetate of 23%), 100 parts by weight

Isocyanate-type hardener (trade name: D-90; produced by Soken Chemical & Engineering Co., Ltd.; total solid concentration in ethylacetate of 90%), 1.5 parts by weight

(2) Evaluation of Filler Lens

\mathring{1} Observation of Filler Layer

With respect to the filler lenses of Samples 6-1 and 6-2, embedding states of the fillers were observed by an electron microscope. As a result, the fillers were seen to have been almost uniformly dispersed in the binding layer at a high density. In the filler lenses of Samples 6-1 and Sample 6-2, the fillers uniformly protruded from the surface of the binding layer so that about 70% and 40% of the diameters thereof were embedded in the binding layer, respectively.

\mathring{2} Light Diffusivity Test

With respect to the above filler lenses of Samples 6-1 to 6-4, total light diffusion transmittance: T % and total light diffusion reflectance: R % in the cases in which the light was transmitted from the film 1 side as shown in FIG. 12A and in which the light was transmitted from the filler 3 side as shown in FIG. 12B, were measured using a spectrophotometer UV3100 produced by Shimadzu Corporation.

As a measuring method of total light diffusion transmittance: T %, a filler lens is placed between incident light and a standard white board (magnesium sulfate) 10 as shown in FIG. 13A and then the total light diffusion transmittance of light diffused forward is measured. FIG. 13B shows the case in which light is transmitted from the film side, as shown in FIG. 12A; however, also with respect to the case in which light is transmitted from the filler side, as shown in FIG. 12B, total light diffusion transmittance was measured in the same way.

Furthermore, as a measuring method of total light diffusion reflectance: R %, first, light is transmitted on a standard white board (magnesium sulfate), then, total light diffusion reflectance of light diffused backward is measured, and the measured value is defined as 100. Secondly, total light diffusion reflectance thereof is measured by emitting light to a filler lens L as shown in FIG. 13B, and then it is calculated as a ratio of the total light diffusion reflectance of the above standard white board. FIG. 13B shows the case in which light is transmitted from the film side, as shown in FIG. 12A; however, also with respect to the case in which light is transmitted from the filler side, as shown in FIG. 12B, total light diffusion reflectance was measured in the same way. In this case, the measuring wavelength was in a range of 400 to 700 nm, and the measured value is shown by the average value in this wavelength range.

\mathring{3} Reliability Test

The above filler lenses of Samples 6-1 to 6-4 were allowed to stand for 3 days in high-temperature and high-humidity conditions (80° C., 90%). Consequently, the light diffusivity was tested in the same manner as above and the high-temperature and high-humidity resistance, that is, the reliability under high temperature and high humidity, was evaluated.

\mathring{4} Evaluation of Adhesion

Adhesion thereof was measured according to Japanese Industrial Standard Z-0237, using binding layers (thickness of 10 μm after drying) in which each coating solution for binding layers of the above Samples 6-1 to 6-4 was coated on a PET film and was dried. Each adhesion thereof before curing and after curing (same curing conditions as Sample 6-1) was evaluated.

These results are shown in Table 7.

TABLE 7

| | Before Standing under High Temperature | | | | After Standing under High Temperature | | | | | |
|---|---|---|---|---|---|---|---|---|---|---|
| | and High Humidity | | | | and High Humidity | | | | Adhesion | |
| | Light Transmitting | | Light Transmitting | | Light Transmitting | | Light Transmitting | | (g/25 mm) | |
| | from Film Side | | from Filler Side | | from Film Side | | from Filler Side | | Before | After |
| | T% | R% | T% | R% | T% | R% | T% | R% | Curing | Curing |
| Sample 6-1 | 73.1 | 42.8 | 98.3 | 26.4 | 71.9 | 43.0 | 98.1 | 26.0 | 250 | 80 |
| Sample 6-2 | 67.8 | 41.6 | 97.7 | 24.3 | 66.9 | 41.1 | 96.6 | 23.7 | 230 | 70 |
| Sample 6-3 | 91.3 | 26.7 | 91.4 | 26.5 | 91.1 | 26.2 | 91.4 | 26.3 | 20 | 0 |
| Sample 6-4 | 75.4 | 38.7 | 92.9 | 25.0 | 80.1 | 31.6 | 89.8 | 27.6 | 600 | 200 |

As shown in Table 7, in Sample 6-3 in which fillers were dispersed in resin, in the case in which light was transmitted from either the film side or the filler side, total light diffusion transmittance was about 91% and total light diffusion reflectance was about 26%, and there was no difference. In contrast, with respect to light diffusivities of Samples 6-1, 6-2, and 6-4, there were differences between light transmitting directions from the film side and from the filler side. In the case in which light was transmitted from the film side, total light diffusion transmittance was lower than in Sample 6-3 and total light diffusion reflectance was higher. In contrast, in the case in which light was transmitted from the filler side, total light diffusion transmittance was extremely high and total light diffusion reflectance was low.

In addition, after being left under high-temperature and high humidity conditions, with respect to light diffusivity of Samples 6-1 to 6-3, there were slight differences; however, with respect Sample 6-4 in which adhesive in the binding layer had not cured, total light diffusion transmittance was increased and total light diffusion reflectance was decreased. That is, according to a filler lens the present invention, a filler lens can be obtained in which a lens effect in which light diffusivities are different depending on the light transmitting direction can be obtained, and in which specific light diffusivities can be maintained even if it is left in high temperatures and high humidity. In addition, in the filler lens of Sample 6-4, since the curing reaction was partially progressed in drying and aging before embedding of the fillers, the uniform filler layer cannot be formed, and the optical properties thereof were inferior.

7. Applications of Filler Lens

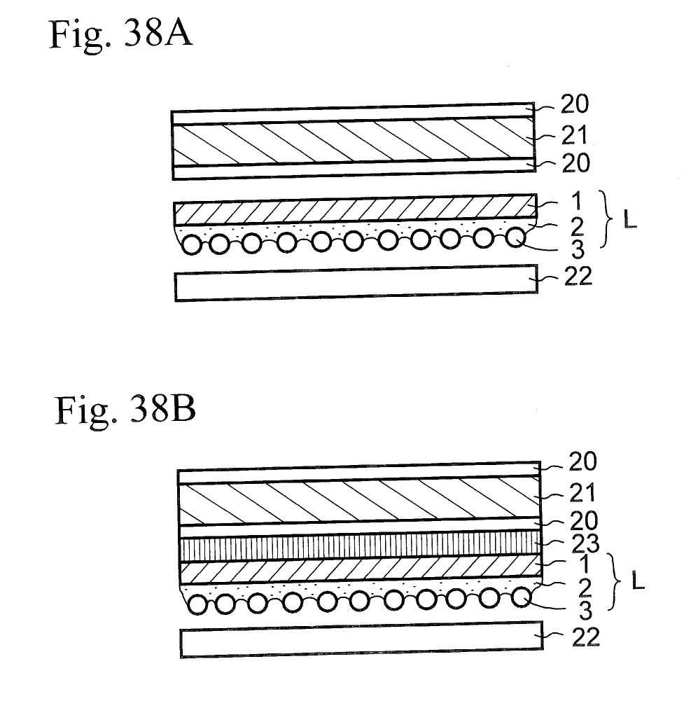

Specifically, in the case in which the filler lens of the present invention is used for a transmitting type liquid crystal display, a filler lens L is placed between a liquid crystal cell 21 providing with polarizing plates 20 on both surfaces and a back light unit 22 as shown in FIG. 38A so as to face the liquid crystal cell 21 side. Alternatively, an adhesive layer 23 is provided on a film 1 surface thereof and a filler lens L is adhered to a polarizing plate 20, as shown in FIG. 38B. Light transmittance of the back light unit 22 is thereby very high, and in addition, sunlight or fluorescent light transmitted from the front side (upper side in the figure) of the display is easily reflected. Therefore, the quantity of light which illuminates the liquid crystal cell 21 is greatly increased, and clarifying and power-saving effects for the liquid crystal images can be obtained. Furthermore, since the filler lens L of the present invention has superior light diffusivity, a background color due to the back light unit 22 can be close to a paper white color, and the contrast of the liquid crystal display can thereby be improved.

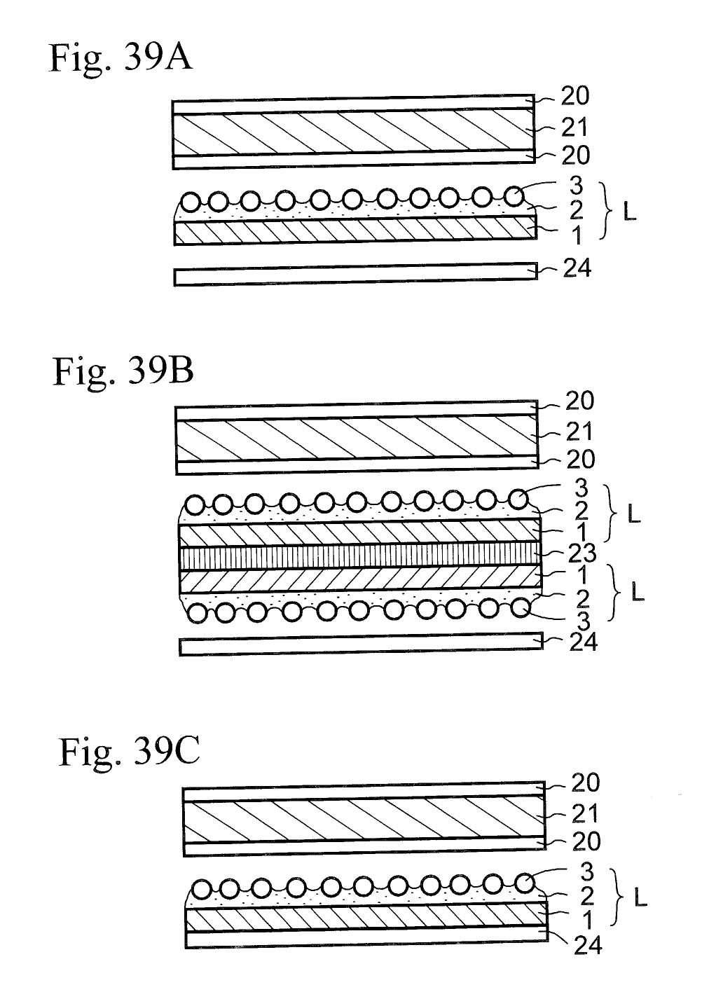

In the case in which the filler lens of the present invention is used for a reflecting type liquid crystal display, a filler lens L is placed between a liquid crystal cell 21 providing with polarizing plates 20 on both surfaces and a reflecting plate 24 as shown in FIG. 39A. Alternatively, each film 1 of two filler lenses L is adhered via an adhesive layer 23, as shown in FIG. 39B, and this can be used as a light diffusion member. In this case, other light diffusion members can also be adhered instead of one of the filler lenses L. Furthermore, an aluminum deposited layer 25 is formed on the film 1 of filler lens L as shown in FIG. 39C, and this can also be used as a diffusive reflecting plate. Therefore, the present invention can efficiently transmit and diffuse the light.

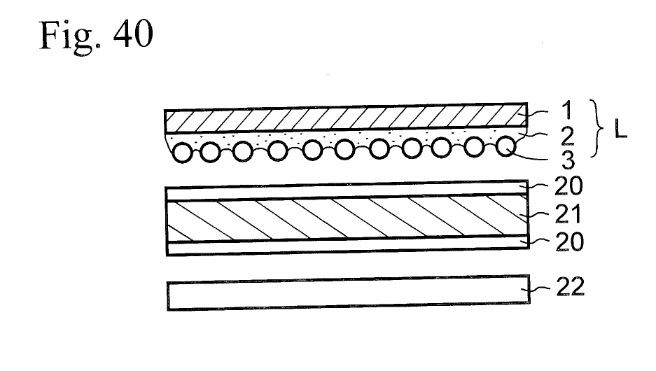

Furthermore, in the case in which the filler lens L is placed on the front side of the liquid crystal cell 21 so as to face the front, as shown in FIG. 40, transmittance of the back light unit 22 is high, and this can also be used as a light diffusion lens having a very wide viewing angle.

As explained above, according to the present invention, a filler layer is formed as a monolayer on the surface of a binding layer laminated on a base material, so that part of the filler protrudes from the surface of this binding layer. Additionally, since the fillers are uniformly placed on the binding layer in the planar direction at high density, the light diffusivity transmitted from the base material side is different from that of from the filler layer side, or a lens effect of the fillers is increased. As the result, lens effects appropriate for various purposes can be provided. Therefore, since the transmitted light is slightly degraded in the case in which a filler lens of the present invention is used for displays such as LCDs, ELs, FEDs, etc., liquid crystal displays having a wide viewing angle, high brightness, and high contrast, can be designed, and extremely superior commercially applicable effects can be exhibited.

1. A production method for a filler lens, the filler lens comprising a base material, a binding layer provided on said base material directly or via another layer, and a filler layer consisting of plural fillers embedded in the surface of said binding layer so that part of said filler protrudes from the surface thereof, the method comprising:
forming said binding layer on said base material directly or via another layer,
embedding said fillers in a surface of said binding layer by pressure media, and
removing surplus fillers adhered to a laminated film formed above.

2. A production method for a filler lens, the filler lens comprising a base material, a binding layer provided on said base material directly or via another layer, and a filler layer consisting of plural fillers embedded in the surface of said binding layer so that part of said filler protrudes from the surface thereof, wherein said binding layer has a gel percentage of 60% or more, and a protruding ratio of said filler is 50% or more, the method comprising:
forming said binding layer on said base material directly or via another layer,
curing said binding layer so that a gel percent thereof is 60% or more,
embedding said fillers in a surface of said binding layer by pressure media so that the protruding ratio of said filler is 50% or more, and
removing surplus fillers adhered to a laminated film formed above.

3. A production method for a filler lens, the filler lens comprising a base material, a binding layer provided on said base material directly or via another layer, and a filler layer consisting of plural fillers embedded in the surface of said binding layer so that part of said filler protrudes from the surface thereof, wherein an elevated portion of said binding layer is provided around said filler, the method comprising:
forming said binding layer on said base material directly or via another layer,
embedding said fillers in a surface of said binding layer by pressure media,
removing surplus fillers adhered to a laminated film formed above, and
softening said binding layer in said laminated film.

4. A production method for a filler lens, a filler lens comprising a base material, a binding layer provided on said base material directly or via another layer, and a filler layer consisting of plural fillers embedded in the surface of said binding layer so that part of said filler protrudes from the surface thereof, wherein said binding layer is cured by a cure-controlled hardener, the method comprising:
forming said binding layer on said base material directly or via another layer,
embedding said fillers in a surface of said binding layer by pressure media,
curing said binding layer, and
removing surplus fillers adhered to a laminated film formed above.

5. A production method for a filler lens, as recited in one of claims 1 to 4, further comprising: adhering said fillers to a surface of said binding layer before embedding said fillers in a surface of said binding layer by pressure media.

6. A production method for a filler lens, as recited in one of claims 1 to 4, wherein said pressure media is granular, and said fillers are embedded in a surface of said binding layer by vibrating said pressure media and by striking said filler.

7. A production method for a filler lens, as recited in claim 6, wherein the granular pressure media particles have a diameter of 2 mm or less.

8. A production method for a filler lens, as recited in one of claims 1 to 4, wherein said surplus fillers are removed by water or a by solution.
